(19) United States
(12) Patent Application Publication
(10) Pub. No.: US 2026/0237015 A1
(43) Pub. Date: Aug. 13, 2026

(54) DIGITAL WATERMARKING FOR VALIDATION OF AUTHENTICITY

(71) Applicant: DIGIMARC CORPORATION, Beaverton, OR (US)

(72) Inventors: Dominique Guinard, Troistorrents (CH); Peter James, Kenley (GB); Kenneth Sickles, Arvada, CO (US)

(21) Appl. No.: 19/158,001

(22) PCT Filed: Mar. 11, 2024
(86) PCT No.: PCT/US2024/019423

§ 371 Date: Aug. 19, 2025

Related U.S. Application Data
(60) Provisional application No. 63/451,178, filed on Mar. 9, 2023.
(60) Provisional application No. 63/464,350, filed on May 5, 2023.

(51) Int. Cl. G06T 1/00; G06Q 30/018; H04L 9/40

(52) U.S. Cl. CPC G06T 1/005; G06Q 30/0185; H04L 63/0823; G06T 2201/0064; G06T 2201/0065

(57) ABSTRACT

The present disclosure relates generally to image signal processing including digital watermarking. Digital watermarking can be used to prevent counterfeiting by binding or tying together digital imagery, products depicted in the digital imagery, and website hosting address information associated with the digital imagery. Various combinations and technology are described in this patent document and claims.

### RELATED APPLICATION DATA

This application relates to assignee's U.S. Provisional Patent Application Nos. 63/464,350, filed May 5, 2023, and 63/451,178, filed Mar. 9, 2023. This application relates generally to assignee's U.S. Provisional Patent Application Nos. 63/433,848, filed Dec. 20, 2022, 63/435,043, filed Dec. 23, 2022, and 63/445,635, filed Feb. 14, 2023, and U.S. patent application Ser. No. 17/992,823, filed Nov. 22, 2022, and PCT Application No. PCT/US22/50767, filed Nov. 22, 2022. Each of the above patent documents are each hereby incorporated herein by reference in its entirety.

### TECHNICAL FIELD

The disclosed technology relates generally to complex image signal processing including digital watermarking and digital image authentication.

### BACKGROUND AND SUMMARY

The term “steganography” generally implies data hiding. One form of data hiding includes digital watermarking. For purposes of this disclosure, the terms “digital watermark,” “watermark” and “data hiding” are used interchangeably. We sometimes use the terms “embedding,” “embed,” “encoding,” “encode” and data hiding” to interchangeably mean modulating or transforming data representing digital content to include information therein. For example, data hiding may seek to hide or embed an information signal (e.g., a plural bit payload or a modified version of such, e.g., a 2-D error corrected, spread spectrum signal) in a host signal. This can be accomplished, e.g., by modulating a host signal (e.g., representing digital content) in some fashion to carry the information signal. We sometimes use the terms “encoder” and “embedder” to interchangeably means software, circuitry, an apparatus and/or module to modulate or transform data representing digital content to include information therein. Similarly, we sometimes use the terms “decode,” “detect” and “read” (and various forms thereof) to interchangeably mean analyzing content to obtain a payload or signal element embedded or encoded therein. Similarly, we sometimes use the terms “decoder,” “detector” and “reader” to interchangeably means software, circuitry, apparatus and/or module to analyze content to obtain a payload or signal element embedded or encoded therein.

Digimarc Corporation headquartered in Beaverton, Oregon, USA, is a leader in the field of digital watermarking. Some of Digimarc's work in steganography, data hiding and digital watermarking is reflected, e.g., in U.S. Pat. Nos. 11,410,262; 11,410,261; 11,188,996; 11,188,996; 11,062,108; 10,652,422; 10,453,163; 10,282,801; 6,947,571; 6,912,295; 6,891,959. 6,763,123; 6,718,046; 6,614,914; 6,590,996; 6,408,082; 6,122,403 and 5,862,260, and in published PCT specifications nos. WO2016153911 and WO2020186234. Each of these patent documents is hereby incorporated by reference herein in its entirety. Of course, a great many other approaches are familiar to those skilled in the art. The artisan is presumed to be familiar with a full range of literature concerning steganography, data hiding and digital watermarking.

One aspect of the disclosure is an image processing method comprising: accessing digital imagery depicting a physical product from a hosting address, the digital imagery comprising digital watermarking embedded therein, the digital watermarking carrying a plural-bit payload comprising validation clues, the validation clues comprising product identification information for the physical product depicted in the digital imagery and hosting address information; analyzing, using a digital watermark decoder, the digital imagery to decode the plural-bit payload, said analyzing yielding decoded validation clues comprising decoded product identification information for the physical product depicted in the digital imagery and decoded hosting address information; scraping validation clues from data associated with the hosting address, said scraping yielding scraped product identification information and scraped hosting address information; generating a comparison based on the scraped validation clues and the decoded validation clues; and determining whether the depicted physical product is authorized or genuine based on said comparison.

In one implementation, the generating a comparison comprises generating a hash of the scraped validation clues, in which the decoded validation clues comprises a decoded hash, and in which the comparison represents a comparison of the generated hash and the decoded hash. In some cases, the scraped validation clues each comprises clear text representing the scraped product identification information and scraped hosting address information, and in which the decoded product identification information for the physical product depicted in the digital imagery and decoded hosting address information each comprises clear text. The scraped product identification information and the decoded product identification information may each comprise at least one of a Stock Keeping Unit (SKU), a Manufacturer Part Number (MPN), an Amazon Standard Identification Number (ASIN), a Global Trading Item Number (GTIN), a Universal Product Code (UPC), an International Standard Book Number (ISBN), a European Article Number (EAN), or a GS1 Digital link.

In one implementation, the scraped hosting address information and the decoded hosting address information each comprise at least one of a plain text address, or a Uniform Resource Identifier (URI), or a reduced-bit version of either.

In another implementation, the scraped hosting address information and the decoded hosting address information may each comprise at least Secure Sockets Layer (SSL) certificate information. The SSL certification information may comprises at least one item from the following group of items: domain name, website address, organizational name certificate issued to, issuing authority, issuing authority's digital signature, certificate issue date, certificate expiry date, authority key identifier (AKID), and subject key identifier (SKID).

The disclosure also provides support for an image processing method comprising: accessing digital imagery depicting a physical product from a hosting address, the digital imagery comprising digital watermarking embedded therein, the digital watermarking carrying a plural-bit payload comprising validation clues, the validation clues comprising hosting address information, analyzing, using a digital watermark decoder, the digital imagery to decode the plural-bit payload, said analyzing yielding decoded validation clues comprising decoded hosting address information, scraping validation clues from data associated with the hosting address, said scraping yielding scraped validation clues comprising scraped hosting address information, generating a comparison based on the scraped validation clues and the decoded validation clues, determining whether the depicted physical product is authorized or genuine based on said comparison. In a first example of the method in which the validation clues also comprise product identification information for the physical product depicted in the digital imagery, and in which the decoded validation clues also comprise decoded product identification information for the physical product depicted in the digital imagery, and in which the scraped validation clues also comprise scraped product identification information. In a second example of the method, optionally including the first example in which said generating a comparison comprises generating a hash of the scraped validation clues, in which the decoded validation clues comprise a decoded hash, and in which the comparison represents a comparison of the generated hash and the decoded hash. In a third example of the method, optionally including one or both of the first and second examples in which the scraped validation clues each comprises clear text representing the scraped product identification information and scraped hosting address information, and in which the decoded product identification information for the physical product depicted in the digital imagery and decoded hosting address information each comprises clear text. In a fourth example of the method, optionally including one or more or each of the first through third examples in which the scraped product identification information and the decoded product identification information each comprise at least one of a Stock Keeping Unit (SKU), a Manufacturer Part Number (MPN), a Global Trading Item Number (GTIN), an Amazon Standard Identification Number (ASIN), a Universal Product Code (UPC), an International Standard Book Number (ISBN), a European Article Number (EAN), or a GS1 Digital Link. In a fifth example of the method, optionally including one or more or each of the first through fourth examples in which the scraped hosting address information and the decoded hosting address information each comprise a plain text address, or a Uniform Resource Identifier (URI), or a reduced-bit version of either. In a sixth example of the method, optionally including one or more or each of the first through fifth examples in which the scraped hosting address information and the decoded hosting address information each comprise at least Secure Sockets Layer (SSL) certificate information. In a seventh example of the method, optionally including one or more or each of the first through sixth examples in which the SSL certification information comprises at least one item from the following group of items: domain name, website address, organizational name certificate issued to, issuing authority, issuing authority's digital signature, certificate issue date, certificate expiry date, authority key identifier (AKID), and subject key identifier (SKID). In an eighth example of the method, optionally including one or more or each of the first through seventh examples in which said analyzing calls a remotely located digital watermark decoder. In a ninth example of the method, optionally including one or more or each of the first through eighth examples in which said acts are carried out within a web browser extension, plug-in or cloud-based service.

The disclosure also provides support for a non-transitory computer readable medium comprising software instructions stored thereon that, when executed by one or more multi-core processor, cause said one or more multi-core processors to perform the following acts: accessing digital imagery depicting a physical product from a hosting address, the digital imagery comprising digital watermarking embedded therein, the digital watermarking carrying a plural-bit payload comprising validation clues, the validation clues comprising hosting address information, analyzing the accessed digital imagery to decode the plural-bit payload, said analyzing yielding decoded validation clues comprising decoded hosting address information, scraping validation clues from data associated with the hosting address, said scraping yielding scraped validation clues comprising scraped hosting address information, generating a comparison based on the scraped validation clues and the decoded validation clues, determining whether the depicted physical product is authorized or genuine based on said comparison. In a first example of the system in which the validation clues also comprise product identification information for the physical product depicted in the digital imagery, and in which the decoded validation clues also comprise decoded product identification information for the physical product depicted in the digital imagery, and in which the scraped validation clues also comprise scraped product identification information. In a second example of the system, optionally including the first example in which said generating a comparison comprises generating a hash of the scraped validation clues, in which said decoded validation clues comprises a decoded hash, and in which said comparison represents a comparison of the generated hash and the decoded hash. In a third example of the system, optionally including one or both of the first and second examples in which the scraped validation clues each comprises clear text representing the scraped product identification information and scraped hosting address information, and in which the decoded product identification information for the physical product depicted in the digital imagery and decoded hosting address information each comprises clear text. In a fourth example of the system, optionally including one or more or each of the first through third examples in which the scraped product identification information and the decoded product identification information each comprises at least one of a Stock Keeping Unit (SKU), a Manufacturer Part Number (MPN), a Global Trading Item Number (GTIN), an Amazon Standard Identification Number (ASIN), a Universal Product Code (UPC), an International Standard Book Number (ISBN), a European Article Number (EAN) or a GS1 Digital Link. In a fifth example of the system, optionally including one or more or each of the first through fourth examples in which the scraped hosting address information and the decoded hosting address information each comprises at least one of a plain text address, or a Uniform Resource Identifier (URI), or a reduced-bit version of either. In a sixth example of the system, optionally including one or more or each of the first through fifth examples in which the scraped hosting address information and the decoded hosting address information each comprises at least Secure Sockets Layer (SSL) certificate information. In a seventh example of the system, optionally including one or more or each of the first through sixth examples in which the SSL certification information comprises at least one item from the following group of items: domain name, website address, organizational name certificate issued to, issuing authority, issuing authority's digital signature, certificate issue date, certificate expiry date, authority key identifier (AKID), and subject key identifier (SKID). In an eighth example of the system, optionally including one or more or each of the first through seventh examples in which said analyzing calls a remotely located digital watermark decoder to carry out said act of analyzing. In a ninth example of the system, optionally including one or more or each of the first through eighth examples in which said software instructions are incorporated within a web browser extension, plug-in or cloud-based service.

Additional aspects, features, combinations, and advantages will be readily apparent with reference to the following figures and the Detailed Description.

### BRIEF DESCRIPTION OF THE DRAWINGS

FIG. 1 is a block diagram of a signal encoder for encoding a data signal into host digital content.

FIG. 2 is a block diagram of a signal decoder for extracting a data signal from host digital content.

FIG. 3 is a flow diagram illustrating operations of a signal generator.

FIG. 4 is a diagram illustrating communication and process flow for a validation system.

FIG. 5 is a diagram illustrating communication and process flow for another implementation of the validation system in FIG. 4.

FIGS. 6A-6H show brand owner graphical user interfaces included with a counterfeit deterrence system.

FIGS. 7A-7E show reseller graphical user interfaces included with the counterfeit deterrence system.

FIGS. 8A and 8E show a product listed at a Product URL, and FIGS. 8B-8D show graphics associated with validation results.

FIGS. 9A-9C show brand owner graphic user interfaces included with the counterfeit deterrence system.

### DETAILED DESCRIPTION

There are two (2) main sections that follow in this Detailed Description (I. Signal Encoding and Decoding, and II. Digital Watermarking for Validation of Authenticity). These sections and their assigned headings are provided merely to help organize the Detailed Description. Of course, description and implementations under one such section are intended to be combined and implemented with description and implementations from the other such section headings. Thus, the section and headings in this document should not be interpreted as limiting the scope of the description.

### I. Signal Encoding and Decoding

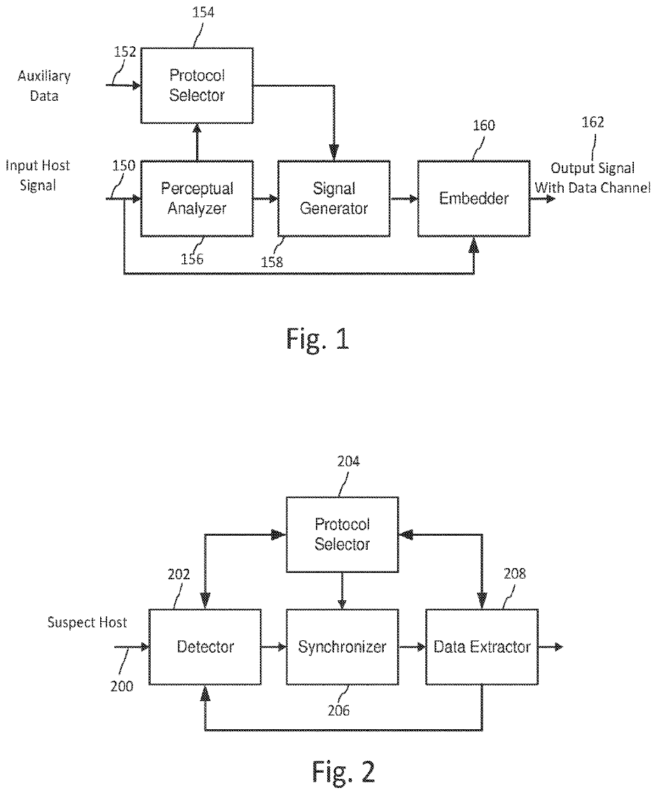

FIG. 1 is a block diagram of a signal encoder for encoding a signal within digital content (e.g., digital image, digital artwork, digital 3D models, digital photographs, digital graphics or designs). We sometimes refer to the signal as an “encoded signal,” “embedded signal” or “digital watermark signal”. We use the term “signal embedder” interchangeably with “signal encoder.” More generally, we use the terms “encoder” and “embedder” interchangeably. One example of a signal encoder or a signal embedder is a “digital watermark embedder” or “digital watermark encoder”. FIG. 2 is a block diagram of a compatible signal decoder for extracting a payload from a signal encoded within the digital content. We use the terms “read,” “detect,” and “decode” interchangeably. Similarly, we use the terms “decoder,” “reader” and “detector” interchangeably.

Encoding and decoding is typically applied digitally. For example, the encoder generates an output including an embedded signal that can be converted to a rendered form, such as viewable digital content, PDF, displayed image or video, or other viewable digital form. Prior to decoding, and if in an analog form, a decoding device obtains an image or stream of images, and converts (if in analog form) it to an electronic signal, which is digitized and processed by signal decoding modules.

Inputs to the signal encoder include a host signal 150 and auxiliary data 152. The host signal in this context can be the target digital content. The objectives of the encoder include encoding a robust signal with desired capacity per unit of host signal, while maintaining perceptual quality within a perceptual quality constraint. In some cases, there may be very little variability or presence of a host signal, in which case, there is little host interference, on the one hand, yet little host content in which to mask the presence of the data channel visually. Some examples include a region of digital content that is devoid of much pixel variability (e.g., a single, uniform color).

The auxiliary data 152 includes the variable data information (e.g., payload) to be conveyed in the data channel, possibly along with other protocol data used to facilitate the communication.

The protocol defines the manner in which the signal is structured and encoded for robustness, perceptual quality or data capacity. For any given application, there may be a single protocol, or more than one protocol. Examples of multiple protocols include cases where there are different versions of the channel, different channel types (e.g., several signal layers within a host signal). Different protocol versions may employ different robustness encoding techniques or different data capacity. Protocol selector module 154 determines the protocol to be used by the encoder for generating a data signal. It may be programmed to employ a particular protocol depending on the input variables, such as user control, application specific parameters, or derivation based on analysis of the host signal.

Perceptual analyzer module 156 analyzes the input host signal to determine parameters for controlling signal generation and embedding, as appropriate. It is not necessary in certain applications, while in others it may be used to select a protocol and/or modify signal generation and embedding operations. For example, when encoding in a host signal that will be printed or displayed, the perceptual analyzer 156 may be used to ascertain color content and masking capability of the host digital content.

The embedded signal may be included in one of the layers or channels of the digital content, e.g., corresponding to:
Luminance, Chrominance, or in a CIELAB channel (L*, a*, b*);
YUV channel;
a color channel of the digital content, e.g., Red Green Blue (RGB);
components of a color model (Lab, HSV, HSL, etc.);
channels corresponding to Cyan, Magenta, Yellow and/or Black, a spot color layer (e.g., corresponding to a Pantone color), which are specified to be used to print the digital content;
a coating (e.g., varnish, UV layer, lacquer, sealant, extender, primer, etc.);
other material layer (metallic substance, e.g., metallic ink or stamped foil where the embedded signal is formed by stamping holes in the foil or removing foil to leave dots of foil); etc.

The above are typically specified in a digital content file, and are manipulated by an encoder. For example, an encoder is implemented as software modules of a plug-in to Adobe Photoshop or Illustrator processing software. Such software can be specified in terms of image layers or image channels. The encoder may modify existing layers, channels or insert new ones. A plug-in can be utilized with other image processing software, e.g., for Adobe Illustrator.

The perceptual analysis performed in the encoder depends on a variety of factors, including color or colors of the embedded signal, resolution of the encoded signal, dot structure and screen angle used to print image layer(s) with the encoded signal, content within the layer of the encoded signal, content within layers under and over the encoded signal, etc. The perceptual analysis may lead to the selection of a color or combination of colors in which to encode the signal that minimizes visual differences due to inserting the embedded signal in an ink layer or layers within the digital content. This selection may vary per embedding location of each signal element. Likewise, the amount of signal at each location may also vary to control visual quality. The encoder can, depending on the associated print technology in which it is employed, vary embedded signal by controlling parameters such as:
dot shape,
signal amplitude at a dot,
ink quantity at a dot (e.g., dilute the ink concentration to reduce percentage of ink),
structure and arrangement of dot cluster or “bump” shape at a location of a signal element or region of elements. An arrangement of ink applied to x by y two-dimensional array of neighboring locations can be used to form a “bump” of varying shape or signal amplitude, as explained further below.

The ability to control printed dot size and shape is a particularly challenging issue and varies with print technology. Dot size can vary due to an effect referred to as dot gain. The ability of a printer to reliably reproduce dots below a particular size is also a constraint.

The encoded signal may also be adapted according to a blend model which indicates the effects of blending the ink of the signal layer with other layers and the substrate.

In some cases, a designer may specify that the encoded signal be inserted into a particular layer. In other cases, the encoder may select the layer or layers in which it is encoded to achieve desired robustness and visibility (visual quality of the digital content in which it is inserted).

The output of this analysis, along with the rendering method (display or printing device) and rendered output form (e.g., ink and substrate) may be used to specify encoding channels (e.g., one or more color channels), perceptual models, and signal protocols to be used with those channels. Please see, e.g., the work on visibility and color models used in perceptual analysis in U.S. application Ser. No. 14/616,686 (U.S. Pat. No. 9,380,186), Ser. No. 14/588,636 (U.S. Pat. No. 9,401,001) and Ser. No. 13/975,919 (U.S. Pat. No. 9,449,357), Patent Application Publication 20100150434 (now U.S. Pat. No. 9,449,357), and U.S. Pat. No. 7,352,878, which are each hereby incorporated by reference in its entirety.

The signal generator module 158 operates on the auxiliary data and generates a data signal according to the protocol. It may also employ information derived from the host signal, such as that provided by perceptual analyzer module 156, to generate the signal. For example, the selection of data code signal and pattern, the modulation function, and the amount of signal to apply at a given embedding location may be adapted depending on the perceptual analysis, and in particular on the perceptual model and perceptual mask that it generates. Please see below and the incorporated patent documents for additional aspects of this process.

Embedder module 160 takes the data signal and modulates it onto a channel by combining it with the host signal. The operation of combining may be an entirely digital signal processing operation, such as where the data signal modulates the host signal digitally, may be a mixed digital and analog process or may be purely an analog process (e.g., where rendered output layers are combined). As noted, an encoded signal may occupy a separate layer or channel of the digital content file. This layer or channel may get combined into an image in the Raster Image Processor (RIP) prior to printing or may be combined as the layer is printed under or over other image layers on a substrate.

There are a variety of different functions for combining the data and host in digital operations. One approach is to adjust the host signal value as a function of the corresponding data signal value at an embedding location, which is controlled according to the perceptual model and a robustness model for that embedding location. The adjustment may alter the host channel by adding a scaled data signal or multiplying a host value by a scale factor dictated by the data signal value corresponding to the embedding location, with weights or thresholds set on the amount of the adjustment according to perceptual model, robustness model, available dynamic range, and available adjustments to elemental ink structures (e.g., controlling halftone dot structures generated by the RIP). The adjustment may also be altering by setting or quantizing the value of a pixel to particular signal element value.

As detailed further below, the signal generator produces a data signal with data elements that are mapped to embedding locations in the data channel. These data elements are modulated onto the channel at the embedding locations. Again please see the documents incorporated herein for more information on variations.

The operation of combining a signal with other digital content may include one or more iterations of adjustments to optimize the modulated host for perceptual quality or robustness constraints. One approach, for example, is to modulate the host so that it satisfies a perceptual quality metric as determined by perceptual model (e.g., visibility model) for embedding locations across the signal. Another approach is to modulate the host so that it satisfies a robustness metric across the signal. Yet another is to modulate the host according to both the robustness metric and perceptual quality metric derived for each embedding location. The incorporated documents provide examples of these techniques. Below, we highlight a few examples.

For digital content including color images or color elements, the perceptual analyzer generates a perceptual model that evaluates visibility of an adjustment to the host by the embedder and sets levels of controls to govern the adjustment (e.g., levels of adjustment per color direction, and per masking region). This may include evaluating the visibility of adjustments of the color at an embedding location (e.g., units of noticeable perceptual difference in color direction in terms of CIE Lab values), Contrast Sensitivity Function (CSF), spatial masking model (e.g., using techniques described by Watson in US Published Patent Application No. US 2006-0165311 A1, which is incorporated by reference herein in its entirety), etc. One way to approach the constraints per embedding location is to combine the data with the host at embedding locations and then analyze the difference between the encoded host with the original. The rendering process may be modeled digitally to produce a modeled version of the embedded signal as it will appear when rendered. The perceptual model then specifies whether an adjustment is noticeable based on the difference between a visibility threshold function computed for an embedding location and the change due to embedding at that location. The embedder then can change or limit the amount of adjustment per embedding location to satisfy the visibility threshold function. Of course, there are various ways to compute adjustments that satisfy a visibility threshold, with different sequences of operations. See, e.g., U.S. Pat. Nos. 7,352,878, 9,380,186, 9,401,001, 9,449,357, and US Patent Application Publication 20100150434.

The embedder also computes a robustness model in some embodiments. The computing a robustness model may include computing a detection metric for an embedding location or region of locations. The approach is to model how well the decoder will be able to recover the data signal at the location or region. This may include applying one or more decode operations and measurements of the decoded signal to determine how strong or reliable the extracted signal. Reliability and strength may be measured by comparing the extracted signal with the known data signal. Below, we detail several decode operations that are candidates for detection metrics within the embedder. One example is an extraction filter which exploits a differential relationship between a signal element and neighboring content to recover the data signal in the presence of noise and host signal interference. At this stage of encoding, the host interference is derivable by applying an extraction filter to the modulated host. The extraction filter models data signal extraction from the modulated host and assesses whether a detection metric is sufficient for reliable decoding. If not, the signal may be re-inserted with different embedding parameters so that the detection metric is satisfied for each region within the host digital content where the signal is applied.

Detection metrics may be evaluated such as by measuring signal strength as a measure of correlation between the modulated host and variable or fixed data components in regions of the host or measuring strength as a measure of correlation between output of an extraction filter and variable or fixed data components. Depending on the strength measure at a location or region, the embedder changes the amount and location of host signal alteration to improve the correlation measure. These changes may be particularly tailored so as to establish sufficient detection metrics for both the payload and synchronization components of the embedded signal within a particular region of the host digital content.

The robustness model may also model distortion expected to be incurred by the modulated host, apply the distortion to the modulated host, and repeat the above process of measuring visibility and detection metrics and adjusting the amount of alterations so that the data signal will withstand the distortion. See, e.g., U.S. Pat. Nos. 9,380,186, 9,401,001 and 9,449,357 for image related processing; each of these patent documents is hereby incorporated herein by reference.

This modulated host is then output as an output signal 162, with an embedded data channel. The operation of combining also may occur in the analog realm where the data signal is transformed to a rendered form, such as a layer of ink, including an overprint or under print, or a stamped, etched or engraved surface marking. In the case of video display, one example is a data signal that is combined as a graphic overlay to other video content on a video display by a display driver. Another example is a data signal that is overprinted as a layer of material, engraved in, or etched onto a substrate, where it may be mixed with other signals applied to the substrate by similar or other marking methods. In these cases, the embedder employs a predictive model of distortion and host signal interference and adjusts the data signal strength so that it will be recovered more reliably. The predictive modeling can be executed by a classifier that classifies types of noise sources or classes of host signals and adapts signal strength and configuration of the data pattern to be more reliable to the classes of noise sources and host signals.

The output 162 from the embedder signal typically incurs various forms of distortion through its distribution or use. This distortion is what necessitates robust encoding and complementary decoding operations to recover the data reliably.

Turning to FIG. 2, a signal decoder receives a suspect host signal 200 and operates on it with one or more processing stages to detect a data signal, synchronize it, and extract data. The detector is paired with input device in which a sensor or other form of signal receiver captures an analog form of the signal and an analog to digital converter converts it to a digital form for digital signal processing. Though aspects of the detector may be implemented as analog components, e.g., such as preprocessing filters that seek to isolate or amplify the data channel relative to noise, much of the signal decoder is implemented as digital signal processing modules.

The detector 202 is a module that detects presence of the embedded signal and other signaling layers. The incoming digital content is referred to as a suspect host because it may not have a data channel or may be so distorted as to render the data channel undetectable. The detector is in communication with a protocol selector 204 to get the protocols it uses to detect the data channel. It may be configured to detect multiple protocols, either by detecting a protocol in the suspect signal and/or inferring the protocol based on attributes of the host signal or other sensed context information. A portion of the data signal may have the purpose of indicating the protocol of another portion of the data signal. As such, the detector is shown as providing a protocol indicator signal back to the protocol selector 204.

The synchronizer module 206 synchronizes the incoming signal to enable data extraction. Synchronizing includes, for example, determining the distortion to the host signal and compensating for it. This process provides the location and arrangement of encoded data elements of a signal within digital content.

The data extractor module 208 gets this location and arrangement and the corresponding protocol and demodulates a data signal from the host. The location and arrangement provide the locations of encoded data elements. The extractor obtains estimates of the encoded data elements and performs a series of signal decoding operations.

As detailed in examples below and in the incorporated documents, the detector, synchronizer and data extractor may share common operations, and in some cases may be combined. For example, the detector and synchronizer may be combined, as initial detection of a portion of the data signal used for synchronization indicates presence of a candidate data signal, and determination of the synchronization of that candidate data signal provides synchronization parameters that enable the data extractor to apply extraction filters at the correct orientation, scale and start location. Similarly, data extraction filters used within data extractor may also be used to detect portions of the data signal within the detector or synchronizer modules. The decoder architecture may be designed with a data flow in which common operations are re-used iteratively, or may be organized in separate stages in pipelined digital logic circuits so that the host data flows efficiently through the pipeline of digital signal operations with minimal need to move partially processed versions of the host data to and from a shared memory, such as a RAM memory.

### Signal Generator

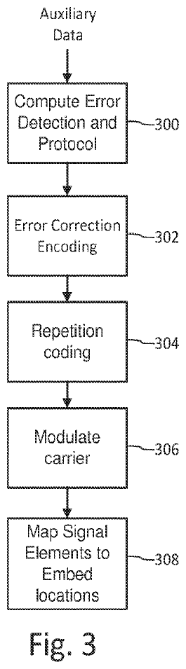

FIG. 3 is a flow diagram illustrating operations of a signal generator. Each of the blocks in the diagram depict processing modules that transform the input auxiliary data (e.g., the payload) into a data signal structure. For a given protocol, each block provides one or more processing stage options selected according to the protocol. In processing module 300, the auxiliary data is processed to compute error detection bits, e.g., such as a Cyclic Redundancy Check, Parity, or like error detection message symbols. Additional fixed and variable messages used in identifying the protocol and facilitating detection, such as synchronization signals may be added at this stage or subsequent stages.

Error correction encoding module 302 transforms the message symbols into an array of encoded message elements (e.g., binary or M-ary elements) using an error correction method. Examples include block codes, convolutional codes, etc.

Repetition encoding module 304 repeats the string of symbols from the prior stage to improve robustness. For example, certain message symbols may be repeated at the same or different rates by mapping them to multiple locations within a unit area of the data channel (e.g., one unit area being a tile of bit cells, bumps or “waxels,” as described further below).

Next, carrier modulation module 306 takes message elements of the previous stage and modulates them onto corresponding carrier signals. For example, a carrier might be an array of pseudorandom signal elements. The data elements of an embedded signal may also be multi-valued. In this case, M-ary or multi-valued encoding is possible at each signal element, through use of different colors, ink quantity, dot patterns or shapes. Signal application is not confined to lightening or darkening an object at a signal element location (e.g., luminance or brightness change). Various adjustments may be made to effect a change in an optical property, like luminance. These include modulating thickness of a layer, surface shape (surface depression or peak), translucency of a layer, etc. Other optical properties may be modified to represent the signal element, such as chromaticity shift, change in reflectance angle, polarization angle, or other forms optical variation. As noted, limiting factors include both the limits of the marking or rendering technology and ability of a capture device to detect changes in optical properties encoded in the signal. We elaborate further on signal configurations below.

Mapping module 308 maps signal elements of each modulated carrier signal to locations within the channel. In the case where a digital host signal is provided, the locations correspond to embedding locations within the host signal. The embedding locations may be in one or more coordinate system domains in which the host signal is represented within a memory of the signal encoder. The locations may correspond to regions in a spatial domain, temporal domain, frequency domain, or some other transform domain. Stated another way, the locations may correspond to a vector of host signal features at which the signal element is inserted.

Various detailed examples of protocols and processing stages of these protocols are provided in, e.g., U.S. Pat. Nos. 6,614,914, 5,862,260, 6,345,104, 6,993,152 and 7,340,076, which are hereby incorporated by reference in their entirety, and US Patent Publication 20100150434, previously incorporated. More background on signaling protocols, and schemes for managing compatibility among protocols, is provided in U.S. Pat. No. 7,412,072, which is hereby incorporated by reference in its entirety.

The above description of signal generator module options demonstrates that the form of the signal used to convey the auxiliary data varies with the needs of the application. As introduced at the beginning of this document, signal design involves a balancing of required robustness, data capacity, and perceptual quality. It also involves addressing many other design considerations, including compatibility, print constraints, scanner constraints, etc. We now turn to examine signal generation schemes, and in particular, schemes that employ signaling, and schemes for facilitating detection, synchronization and data extraction of a data signal in a host channel.

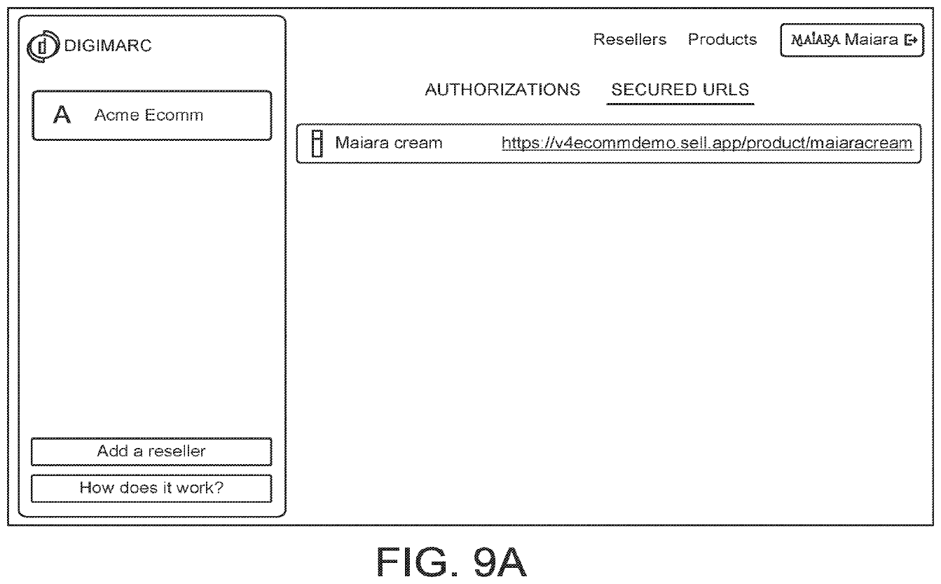

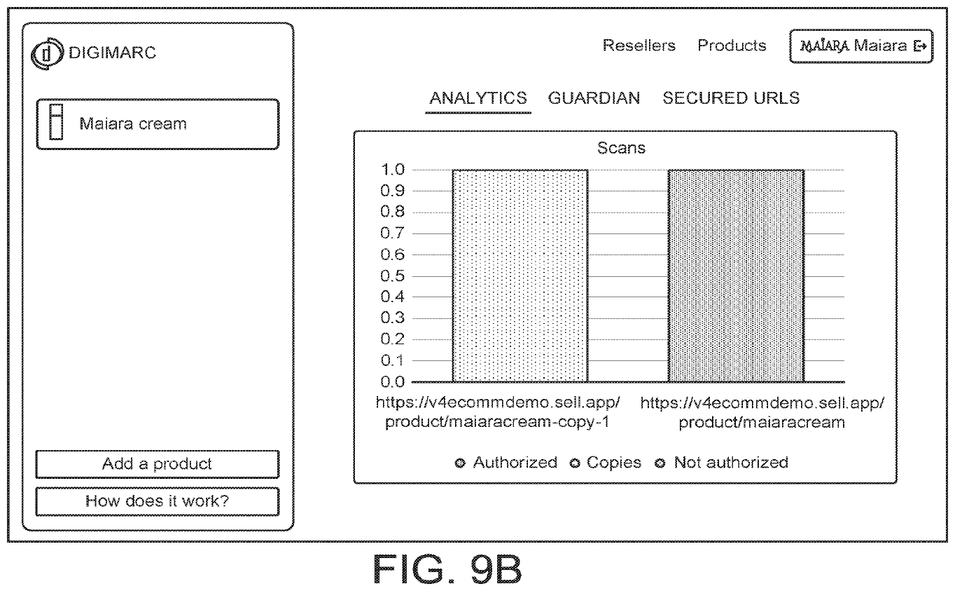

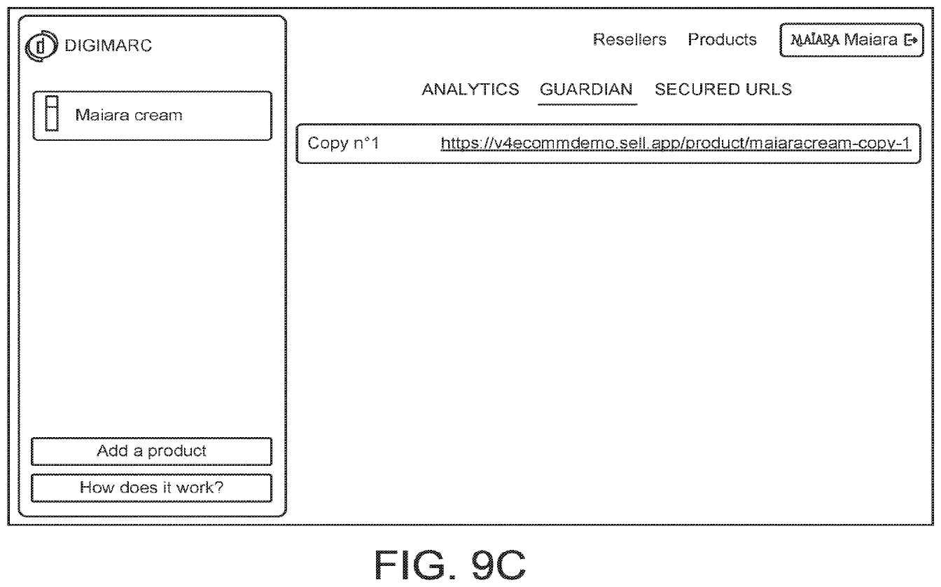

One signaling approach, which is detailed in U.S. Pat. Nos. 6,614,914, and 5,862,260, is to map signal elements to pseudo-random locations within a channel defined by a domain of a host signal. See, e.g., FIG. 9 of U.S. Pat. No. 6,614,914. In particular, elements of a watermark signal are assigned to pseudo-random embedding locations within an arrangement of sub-blocks within a block (referred to as a “tile”). The elements of this watermark signal correspond to error correction coded bits output from an implementation of stage 304 of FIG. 3. These bits are modulated onto a pseudo-random carrier to produce watermark signal elements (block 306 of FIG. 3), which in turn, are assigned to the pseudorandom embedding locations within the sub-blocks (block 308 of FIG. 3). An embedder module modulates this signal onto a host signal by adjusting host signal values at these locations for each error correction coded bit according to the values of the corresponding elements of the modulated carrier signal for that bit.

The signal decoder estimates each coded bit by accumulating evidence across the pseudo-random locations obtained after non-linear filtering a suspect host digital content. Estimates of coded bits at the signal element level are obtained by applying an extraction filter that estimates the signal element at particular embedding location or region. The estimates are aggregated through de-modulating the carrier signal, performing error correction decoding, and then reconstructing the payload, which is validated with error detection.

This pseudo-random arrangement spreads the data signal such that it has a uniform spectrum across the tile. However, this uniform spectrum may not be the best choice from a signal communication perspective since energy of a host digital content may concentrated around DC. Similarly, an auxiliary data channel in high frequency components tends to be more disturbed by blur or other low pass filtering type distortion than other frequency components. A variety of signal arrangements are detailed in U.S. Pat. No. 9,747,656, which are each hereby incorporated by reference in its entirety. This application details several signaling strategies that may be leveraged in the design of encoded signals, in conjunction with the techniques in this document. Differential encoding applies to signal elements by encoding in the differential relationship between a signal element and other signals, such as a background, host elements, or other signal components (e.g., a sync component).

U.S. Pat. No. 6,345,104, building on the disclosure of U.S. Pat. No. 5,862,260, describes that an embedding location may be modulated by inserting ink droplets at the location to decrease luminance at the region, or modulating thickness or presence of line art. Additionally, increases in luminance may be made by removing ink or applying a lighter ink relative to neighboring ink. It also teaches that a synchronization pattern may act as a carrier pattern for variable data elements of a message payload. The synchronization component may be a visible design, within which a sparse data signal (see, e.g., U.S. Pat. No. 11,062,108) or dense data signal is merged. Also, the synchronization component may be designed to be imperceptible, using the methodology disclosed in U.S. Pat. No. 5,862,260.

We further discuss the design, encoding and decoding of signals in more detail. As introduced above, one consideration in the design of an encoded signal is the allocation of signal for data carrying and for synchronization. Another consideration is compatibility with other signaling schemes in terms of both encoder and decoder processing flow. With respect to the encoder, the encoder should be compatible with various signaling schemes, including dense and sparse signaling, so that it each signaling scheme may be adaptively applied to different regions of a digital content design, as represented in a digital content, according to the characteristics of those regions. This adaptive approach enables the user of the encoder tool to select different methods for different regions and/or the encoder tool to be programmed to select automatically a signaling strategy that will provide the most robust signal, yet maintain the highest quality image, for the different regions. Additional details regarding sparse digital watermarking is described in Digimarc's published PCT application no. WO 2020186234, which is hereby incorporated herein by reference in its entirety.

One example of the advantage of this adaptive approach is in a design that has different regions requiring different encoding strategies. One region may be blank, another blank with text, another with a graphic in solid tones, another with a particular spot color, and another with variable image content.

With respect to the decoder, this approach simplifies decoder deployment, as a common decoder can be deployed that decodes various types of data signals, including both dense and sparse signals.

As introduced above with reference to FIG. 3, there are stages of modulation/de-modulation in the encoder, so it is instructive to clarify different types of modulation. One stage is where a data symbol is modulated onto an intermediate carrier signal. Another stage is where that modulated carrier is inserted into the host by modulating elements of the host. In the first case, the carrier might be pattern, e.g., a pattern in a spatial domain or a transform domain (e.g., frequency domain). The carrier may be modulated in amplitude, phase, frequency, etc. The carrier may be, as noted, a pseudorandom string of 1's and 0's or multi-valued elements that is inverted or not (e.g., XOR, or flipped in sign) to carry a payload or sync symbol.

As noted in U.S. Pat. No. 9,747,656, carrier signals may have structures that facilitate both synchronization and variable data carrying capacity. Both functions may be encoded by arranging signal elements in a host channel so that the data is encoded in the relationship among signal elements in the host. U.S. Pat. No. 9,747,656 specifically elaborates on a technique for modulating, called differential modulation. In differential modulation, data is modulated into the differential relationship among elements of the signal. In some watermarking implementations, this differential relationship is particularly advantageous because the differential relationship enables the decoder to minimize interference of the host signal by computing differences among differentially encoded elements. In sparse data signaling, there may be little host interference to begin with, as the host signal may lack information at the embedding location.

Another form of modulating data is through selection of different carrier signals to carry distinct data symbols. One such example is a set of frequency domain peaks (e.g., impulses in the Fourier magnitude domain of the signal) or sine waves. In such an arrangement, each set carries a message symbol. Variable data is encoded by inserting several sets of signal components corresponding to the data symbols to be encoded. The decoder extracts the message by correlating with different carrier signals or filtering the received signal with filter banks corresponding to each message carrier to ascertain which sets of message symbols are encoded at embedding locations.

Having now illustrated methods to modulate data into the watermark (either dense or sparse), we now turn to the issue of designing for synchronization. For the sake of explanation, we categorize synchronization as explicit or implicit. An explicit synchronization signal is one where the signal is distinct from a data signal and designed to facilitate synchronization. Signals formed from a pattern of impulse functions, frequency domain peaks or sine waves is one such example. An implicit synchronization signal is one that is inherent in the structure of the data signal.

An implicit synchronization signal may be formed by arrangement of a data signal. For example, in one encoding protocol, the signal generator repeats the pattern of bit cells representing a data element. We sometimes refer to repetition of a bit cell pattern as “tiling” as it connotes a contiguous repetition of elemental blocks adjacent to each other along at least one dimension in a coordinate system of an embedding domain. The repetition of a pattern of data tiles or patterns of data across tiles (e.g., the patterning of bit cells in U.S. Pat. No. 5,862,260) create structure in a transform domain that forms a synchronization template. For example, redundant patterns can create peaks in a frequency domain or autocorrelation domain, or some other transform domain, and those peaks constitute a template for registration. See, for example, U.S. Pat. No. 7,152,021, which is hereby incorporated by reference in its entirety.

The concepts of explicit and implicit signaling readily merge as both techniques may be included in a design, and ultimately, both provide an expected signal structure that the signal decoder detects to determine geometric distortion.

In one arrangement for synchronization, the synchronization signal forms a carrier for variable data. In such arrangement, the synchronization signal is modulated with variable data. Examples include sync patterns modulated with data.

Conversely, in another arrangement, that modulated data signal is arranged to form a synchronization signal. Examples include repetition of bit cell patterns or tiles.

The variable data and sync components of the encoded signal may be chosen so as to be conveyed through orthogonal vectors. This approach limits interference between data carrying elements and sync components. In such an arrangement, the decoder correlates the received signal with the orthogonal sync component to detect the signal and determine the geometric distortion. The sync component is then filtered out. Next, the data carrying elements are sampled, e.g., by correlating with the orthogonal data carrier or filtering with a filter adapted to extract data elements from the orthogonal data carrier. Signal encoding and decoding, including decoder strategies employing correlation and filtering are described in U.S. Pat. No. 9,747,656.

Additional examples of explicit and implicit synchronization signals are provided in previously cited U.S. Pat. Nos. 6,614,914, and 5,862,260. In particular, one example of an explicit synchronization signal is a signal comprised of a set of sine waves, with pseudo-random phase, which appear as peaks in the Fourier domain of the suspect signal. See, e.g., U.S. Pat. Nos. 6,614,914, and 5,862,260, describing use of a synchronization signal in conjunction with a robust data signal. Also see U.S. Pat. No. 7,986,807, which is hereby incorporated by reference in its entirety.

US Publication No. 20120078989, which is hereby incorporated by reference in its entirety, provides additional methods for detecting an embedded signal with this type of structure and recovering rotation, scale and translation from these methods.

Additional examples of implicit synchronization signals, and their use, are provided in U.S. Pat. Nos. 9,747,656, 7,072,490, 6,625,297, 6,614,914, and 5,862,260, which are hereby incorporated by reference in their entirety.

### II. Digital Watermarking for Validation of Authenticity

Counterfeiting remains king. Illicit trade is rising and growing steadily.

Counterfeit products are continuously getting sneakier, more sophisticated, and harder to distinguish from authentic goods. This puts consumers at risk of using potentially harmful, unauthorized, and/or unregulated products. For example, consider the following staggering statistics. $ 4.2T is the cost of counterfeit goods to the global economy in 2022, according to the International Chamber of Commerce. Seizures of infringing goods at U.S. borders have multiplied 10 times since 2000, according to the U.S. Department of Homeland Security. And, the International Chamber of Commerce projects that counterfeiting and piracy will put 5.4 million legitimate jobs at risk as of 2022.

Combatting these problems benefits from sophisticated, technical solutions, such as those described below.

Consider an online environment having items listed for sale on various retail websites. Consumers often sift through the various websites looking for the right size, color, models, all while looking for the best price. But how does a consumer really know whether a retailer hosting a website is an authorized seller, selling an authentic product? Afterall, there are so many spoofs and shameless scoundrels on the Internet!

Digital watermarking is used to provide validation of authenticity.

Digital watermarking is embedded within product digital imagery of authorized reseller websites to provide validation clues. The term “validation clues” includes information that can be used to validate authenticity of a product and/or reseller. For example, the validation clues may include a product identifier, a brand identifier, an authorized website address (or portion thereof), SSL certification information, retailer identifier, an e-commerce site identifier, lot or batch number, other digital watermark payload information, cryptographic relationships of the foregoing, and all combinations of the foregoing. The digital watermarking preferably alters at least some perceptual elements of the product digital imagery, e.g., alters data representing pixels or color values, luminance or chrominance. In an alternative embedding case, digital watermarking is embedded by altering image DCT coefficients. Example digital image watermarking technology is described above in Section I including in the incorporated by reference patents. The digital watermarking encoded within the product digital imagery preferably carries a plural-bit payload including validation clues. A consumer can deploy a digital watermark decoder to search website digital images to determine whether they include digital watermarking, and whether any decoded digital watermarking payload includes expected validation clues for that particular website and product combination. In one example, the digital watermarking includes both a plural-bit payload and a synchronization signal (or synchronization “component”). Example synchronization signals are discussed above in Section I.

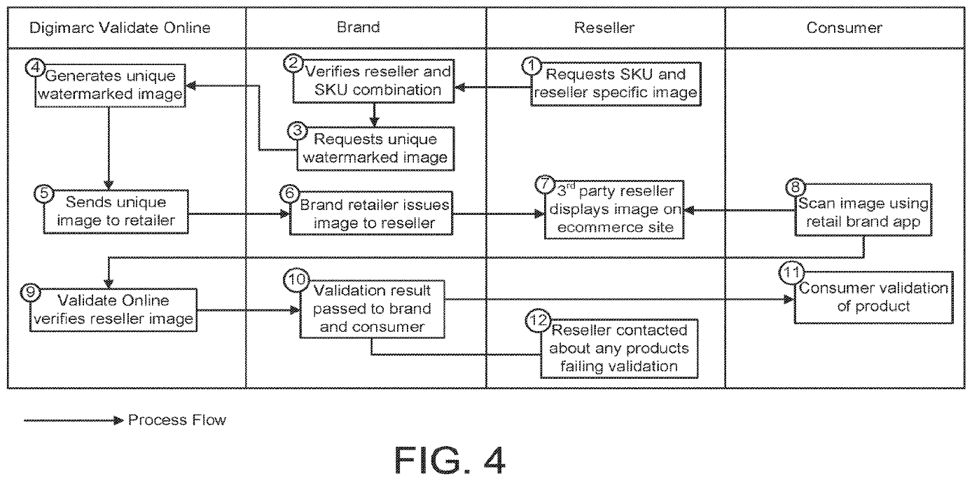

Consider an example where an authorized retailer hosts one or more websites selling goods or services. With reference to FIG. 4, let's say, for example, that the retailer is a sporting goods store (“SGS Reseller”) which sells authentic shoes from the brand, Tartarus Shoes (“Shoe Brand”). (Tartarus is a relatively obscure Greek god, unlike the better-known deity, Nike). The SGS Reseller requests (1) authorized digital images to post on their website from the Shoe Brand. Included with the request (or entered through an online portal hosted by the Shoe Brand) is product identifier information and/or specific website address information. One example of product identifier information is a SKU, short for “stock keeping unit,” which is a number and/or letter combination used by retailers to identify and track products based on their features like price, manufacturer, color, style, type, and size, etc. Other product identifier information includes, e.g., Manufacturer Part Number (MPN), Global Trading Item Number (GTIN), Universal Product Code (UPC), International Standard Book Number (ISBN), and European Article Number (EAN), GS1 Digital Link, to name a few. The website address information can include a plain text address (e.g., www.SGS**Reseller.com), Uniform Resource Identifier (URI) information, Secure Sockets Layer (SSL) certificate information (e.g., domain name or website address, organizational name certificate issued to, issuing authority, issuing authority's digital signature, validity period of certification-such as issue date and expiry date, authority key identifier (AKID), subject key identifier (SKID), and/or public key, etc.), and/or a reduced-bit version of any of the above.

Returning to FIG. 4, the Shoe Brand verifies (2) the SGS Reseller and product identifier combination. For example, the Shoe Brand determines whether this reseller is allowed to resell a product associated with the provided product identifier. The Shoe Brand can consult a database, table or registry to determine whether the combination is allowed. The database, table or registry likely includes or points to digital imagery associated with that product. The digital imagery many include one or more different digital images representing the product. The digital imagery-along with product information and website address information-is provided (3) to a digital watermark embedder. The digital watermark embedder can be hosted by a third-party service (as shown in FIG. 4) or be co-located with a server operated by Shoe Brand. For example implementation, the third-party service may provide one or more interfaces through which the digital imagery can be uploaded, in association with a login or account validation. Suitable digital watermark embedders are discussed above in Section I and in the incorporated by reference patent documents. The digital watermark embedder embeds digital watermarking within the digital imagery (4), creating identifiable watermarked images. The term “identifiable” is used here since the digital watermarking carries validation clues that uniquely associate a product (e.g., via the product identifier information) to a particular website (e.g., via the website address information). The digital watermarking carried validation clues are typically carried in a plural-bit digital watermark payload. In a first implementation, the payload may include, e.g., a concatenated bit-string representing the product identifier information and/or the website address information. In a second implementation, different payload fields carry such information. In a third implementation, the payload carries an index or other identifier that is used to query into a database, table or other data repository. The database, table or other data repository hosts the product identifier information and the website address information, indexed according to the embedded index or other identifier. In a fourth implementation, the plural-bit payload includes a hash or fingerprint representing the data of any of implementations one, two or three. In a fifth implementation, the plural-bit payload includes a concatenated bit-string representing all or a portion of the website address information. In a sixth implementation the payload contains a cryptographically signed version of the data of any implementations one, two, three, four or five.

The embedded (or digitally watermarked) digital imagery is communicated to the retailer (or reseller), e.g., directly (5) or via the Brand (6). For example, the watermarked digital imagery is communicated via the third-party's online interface(s). Or the watermarked digital imagery can be downloaded from the brand or from a validation service. Once received, the SGS Reseller displays the watermarked digital imagery on a corresponding website. Recall from above that the validation clues carried in the digital watermarking ties the depicted product to the corresponding website.

A consumer perusing the corresponding website, e.g., on a mobile device, tablet or desktop computer, now wants to verify a product and corresponding reseller, since he's about to buy a pair of awesome shoes. He doesn't want to be ripped-off, so he activates a validation module (8) to test the authenticity of the product and reseller. The validation module includes or calls a digital watermark decoder. Suitable decoders are discussed above in Section I and in the incorporated by reference patent documents. The digital watermark decoder analyzes the digital imagery displayed on the corresponding website to decode the plural-bit payload carried by the embedded digital watermarking. The validation clues are obtained from the plural-bit payload and are used to validate the product and authority of the reseller to sell the product. We sometimes refer to these validation clues as “decoded validation clues” since they are decoded from digital imagery associated with a product to be verified.

One implementation of the validation module includes a dedicated web browser extension. Such extensions are typically software programs that can modify and enhance the functionality of a web browser. Extensions can be written using, e.g., HTML, CSS (“Cascading Style Sheets”), and/or JavaScript. The web browser extension can deploy a digital watermark detector, e.g., via decoder code incorporated via software instructions within the extension (8) or, alternatively, deployed by being called by the web browser extension (9). If the web browser extension calls a remotely located digital watermark detector, the web browser extension can provide the digital imagery to the digital watermark detector. In another implementation, the web browser extension provides an web address hosting the digital imagery to the digital watermark detection, which accesses the digital content by visiting the web address. The web browser extension allows a consumer to verify the authenticity of the reseller to sell the product depicted in the digital imagery on the corresponding website. For example, the web browser extension, running in the background and/or once activated (e.g., clicking on an icon or displayed widget), deploys a digital watermark detector to analyze the digital imagery. The digital watermark detector analyzes the digital image to locate and decode a plural-bit payload carried therein.

The web browser extension preferably includes functionality, e.g., provided by software instructions, to scrape or collect the corresponding website for information to compare against the decoded digital watermark payload. We sometimes refer to this scraped information as “scraped validation clues.” For example, such scraped information, including product identifier and SSL certificate information, can be typically found associated with the corresponding website (e.g., and found in HTML and/or CSS; and for SSL information: found via execution of command-based tools such as Keytool, OpenSSL, Nmap, and web-based tools such as SurfaceBrowser SSL Analyzer or Qualys SSL Test). If the digital watermark payload includes a hash of such information, the web browser extension can generate a hash of the scraped or collected information using the same algorithm (or key set) as was used to create the digital watermark payload. Alternatively, the web browser extension can call the third-party service for validation. In one implementation, the web browser extension provides scrapped information to the third-party service and an address of the digital imagery. The web browser extension or third-party service decodes the digital watermark payload and performs a comparison with the scrapped information to determine if the product is authorized for resell by the reseller. If SSL certification information is used for validation comparison, different portions of the SSL certificate can be used for validation: e.g., a comparison of the hash of the certificate with the hash carried by the digital watermark embedded within the product digital imagery, by a comparison of the issuer and serial number of the scraped info vs. watermark payload version, and/or by the fingerprint/subject key identifier (SKID) of the scraped info vs. watermark payload version. The validation result can be passed back to the consumer (11) and, optionally, to the Brand (10). A popup window, or other notification, generated by the web browser extension, can display a successful validation to the consumer or display a warning that the validation failed. Providing validation information (e.g., including product information and reseller information) provides powerful crowdsourced counterfeiting surveyance information to the Brand. The Brand can contact the Reseller regarding any failed product validations.

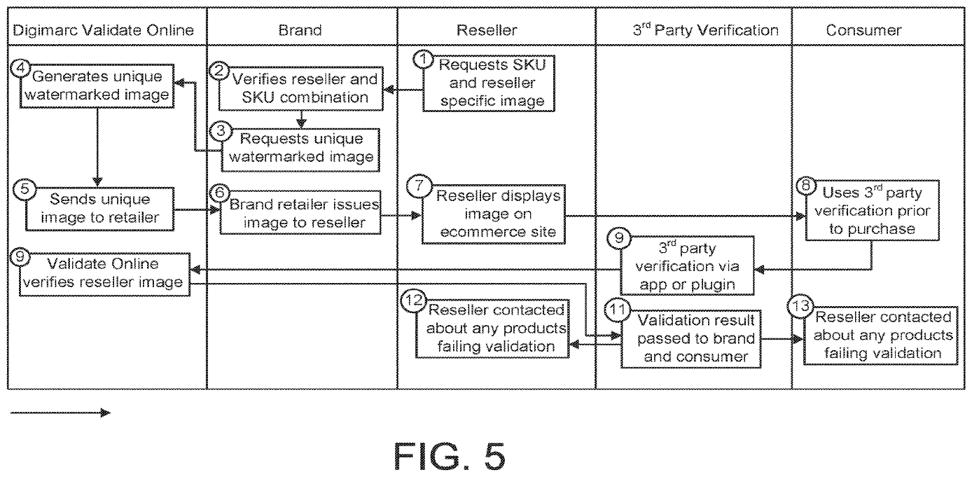

Instead of using a browser extension, the validation module, including the digital watermark detection and validation/comparison features discussed above, can be incorporated into a standalone application or service, which queries particular websites. For example, Reseller could build the validation module into their website platform, e.g., as a feature available to registered customers. In an alternative, a plug-in is used instead of a web browser extension. In still another alternative embodiment, the detection and validation features are provided by a 3^{rd} party verification webpage or web service (see FIG. 5, items 9 and 11). In this case a product can be verified by sending the address (URL) of the product to the webpage or web service. This allows for instance verification in browsers that do not support extensions (e.g., some mobile browsers) and could use for example a bookmarklet-a bookmark stored in a web browser that contains JavaScript commands that add new features to the browser. The 3^{rd} Party Verification can provide a dedicated app, web browser extension or plugin including a validation module. Also, instead of using a web browser extension, a smartphone running a validation app could be used to search for digital watermarking included with displayed or encountered digital imagery. In another implementation, a smartphone captures an image of digital imagery from a computer or smartphone display, and then decodes a digital watermark payload embedded within. A user can capture another image of the website text for comparison, or manually enters or links to the website address. Software scrapes the image including the text using, e.g., Optical Character Recognition (“OCR”) and/or text reading software. A digital watermark comparison between the decoded digital watermark payload and the OCR'ed HTML text (or a cryptographic relationship between such) can be carried out as discussed above to determine a validation. When capturing the digital imagery on a webpage the validation module can also capture the web address of the website, e.g., by applying OCR on the address bar and use it as part of the validation: ensuring the address of the website corresponds to an authorized address for this product by comparing it to the plural-bit payload of the watermark (directly or via a mapping service). It can also capture other elements such as ensuring there is a closed padlock (e.g., graphical icon) in the website address bar next to the website address, hinting that the connection is secure.

Now consider a counterfeit attempt. A screen shot (or simply a “right-click” copy function) is taken of authentically displayed digital imagery from a first website. To be sure, this right-clicked version is an unauthorized copy of authentic digital imagery. But the unauthorized copy carries the digital watermarking as well. That digital watermarking includes a plural-bit payload which is directly linked to the displayed product and corresponding website (the first website). An unscrupulous reseller now uses the copied digital imagery on his website (a second website) to advertise the product, which is likely counterfeit or, at best, a gray market version. Luckily, a dedicated web browser extension is available for a validation check. The web browser extension running in the background and/or once activated (e.g., clicking on an icon or displayed widget) deploys a digital watermark detector to analyze the copied digital imagery. The digital watermark detector analyzes the digital imagery to locate and decode a plural-bit payload carried therein (e.g., decoded validation clues). In this example, the payload includes, e.g., i) a SKU product identifier, and ii) SSL certificate information corresponding to the first website. The web browser extension scrapes, reads or collects information (e.g., scraped information) from the second website that is hosting the copied digital imagery for information to compare against the decoded digital watermarking plural-bit payload. The web browser extension finds the correct SKU product identifier, but SSL certificate information for the second website. So, the validation comparison will fail since the compared information (SSL information for first website vs. SSL information for the second website) does not match in an expected manner. “Match” in this context can be a cryptographic relationship, a comparison of hashes, where the hashes represent reduced-bit versions of scaped and decoded information, a direct match (letter or character by letter or character), or match within a predetermined tolerance. A popup window, or other notification, generated by the web browser extension, can display the failed information and that the product is not authentic or is otherwise not authorized.

In another payload example, the digital watermark payload includes, e.g., i) a SKU product identifier, and/or ii) the web address corresponding to the listing of the product on the first website. The web browser extension scrapes or collects information from the second website that is hosting the copied digital imagery for information to compare against the decoded digital watermarking plural-bit payload. The web browser extension finds the correct SKU product identifier, but the web address (URL) of the second website. So, the validation comparison will fail since the compared information (website address of the first website vs website address of the second website do not match) does not match in an expected manner. Similar to above, “match” in this context can be a cryptographic relationship, a comparison of hashes, where the hashes represent reduced-bit versions of scaped and decoded information, a direct match (letter or character by letter or character), or match within a predetermined tolerance. A popup window, or other notification, generated by the web browser extension, can display the failed information and that the product is not authentic or is otherwise not authorized.

In still another payload example, the digital watermark payload includes, e.g., some or all of the web address corresponding to the listing of the product on the first website. The web browser extension scrapes or collects information from the second website that is hosting the copied digital imagery for information to compare against the decoded digital watermarking plural-bit payload. The web browser extension finds the web address (URL) of the second website. So, the validation comparison will fail since the compared information is different or does not match in the expected manner (website address of the first website vs website address of the second website do not match). Similar to above, “match” in this context can be a cryptographic relationship, a comparison of hashes, where the hashes represent reduced-bit versions of scaped and decoded information, a direct match (letter or character by letter or character), or match within a predetermined tolerance. A popup window, or other notification, generated by the web browser extension, can display the failed information and that the product is not authentic or is otherwise not authorized.

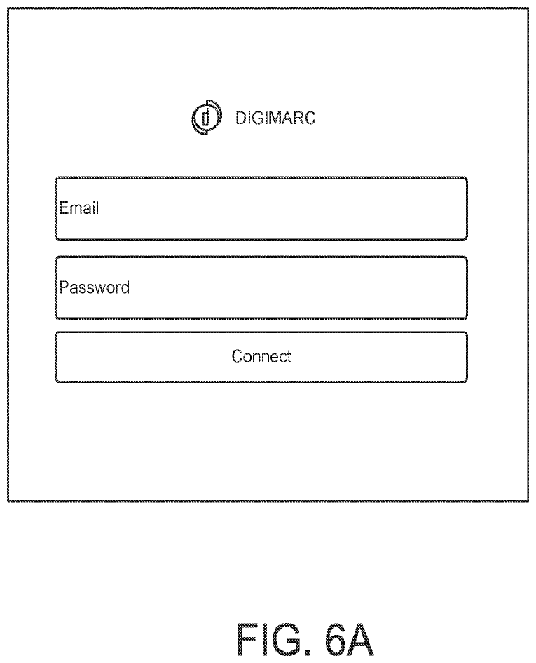

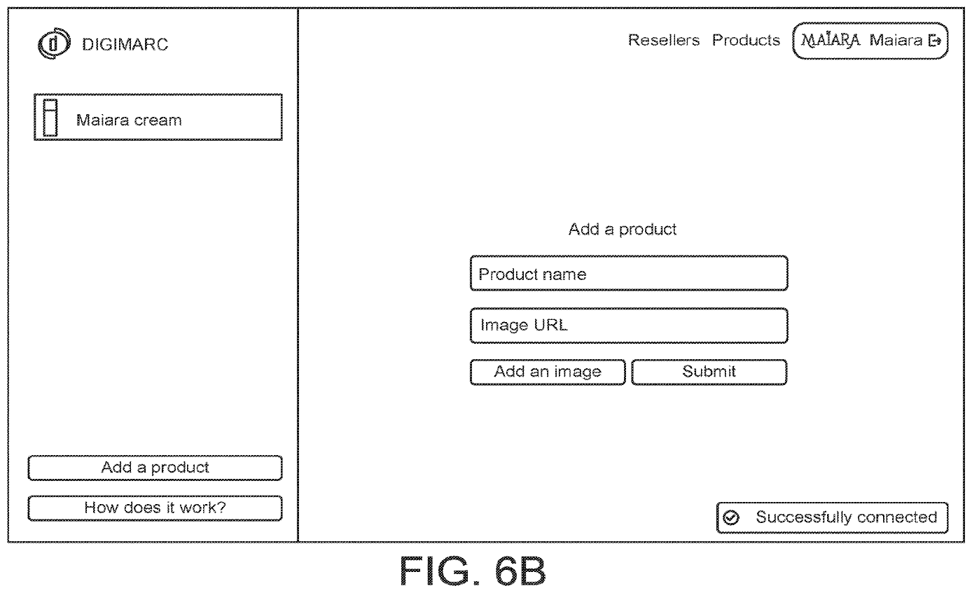

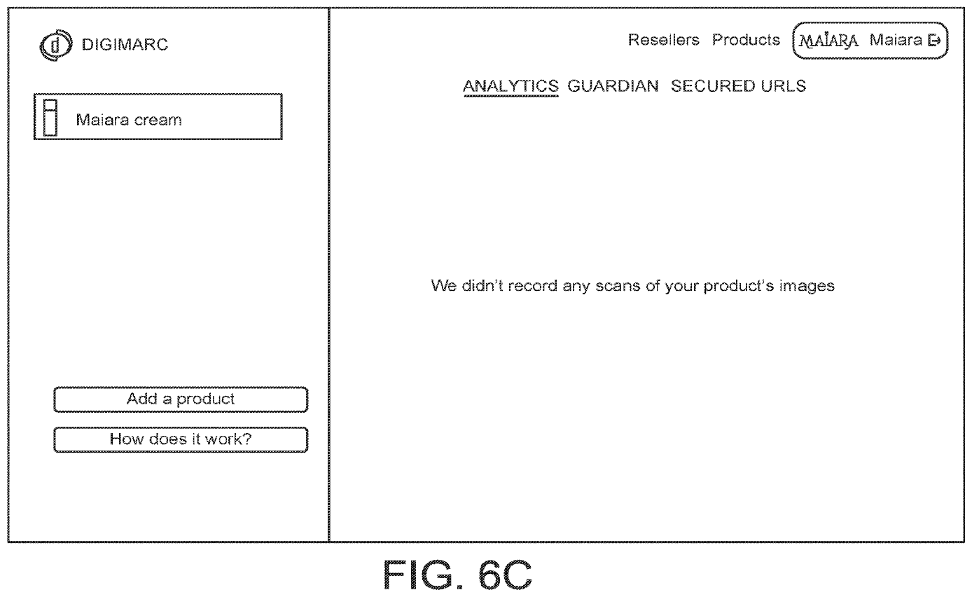

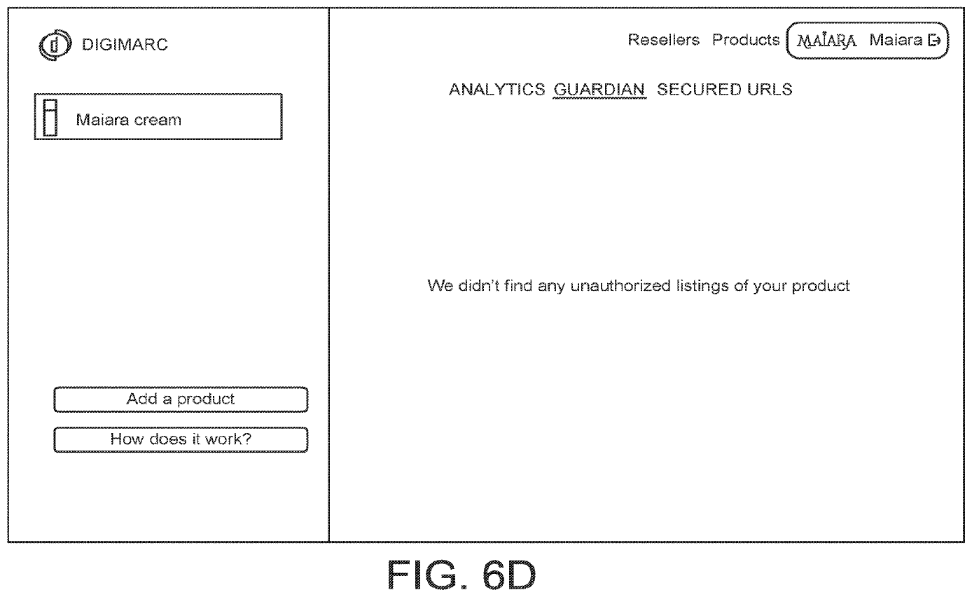

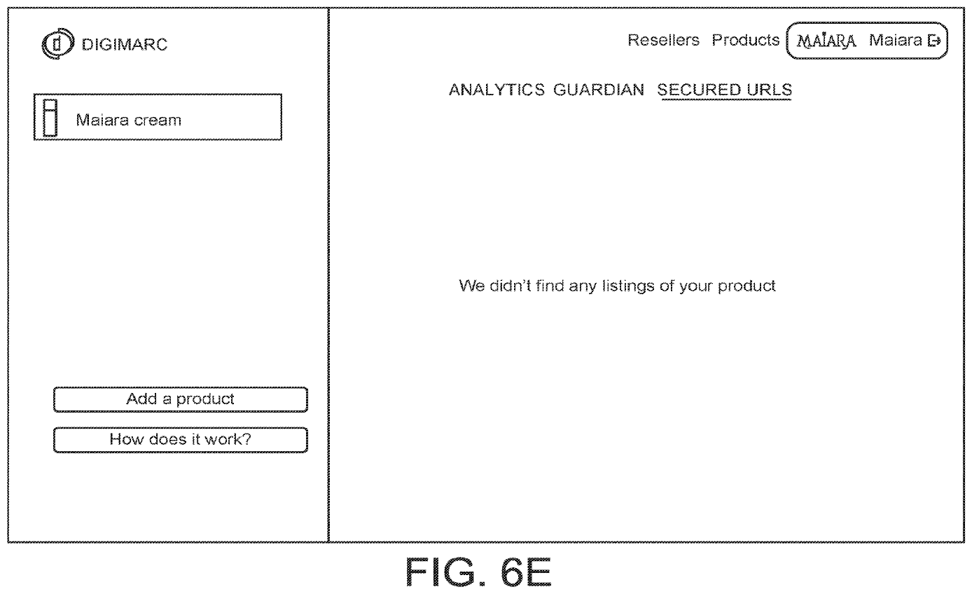

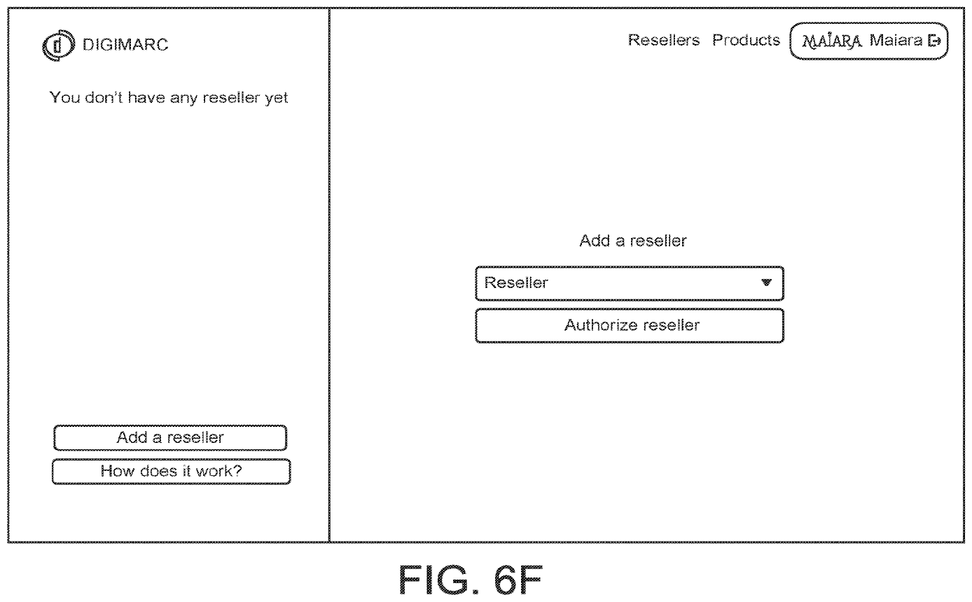

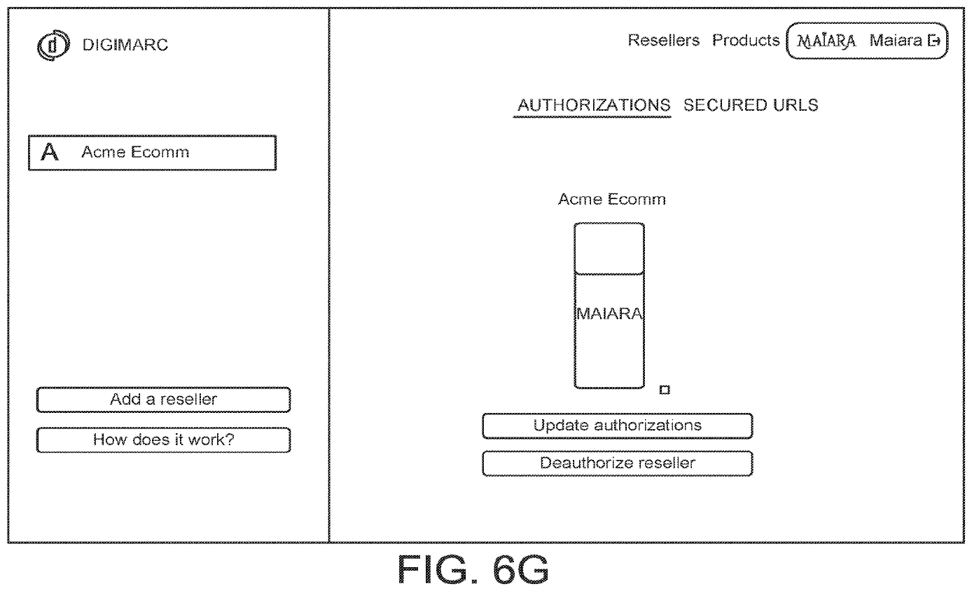

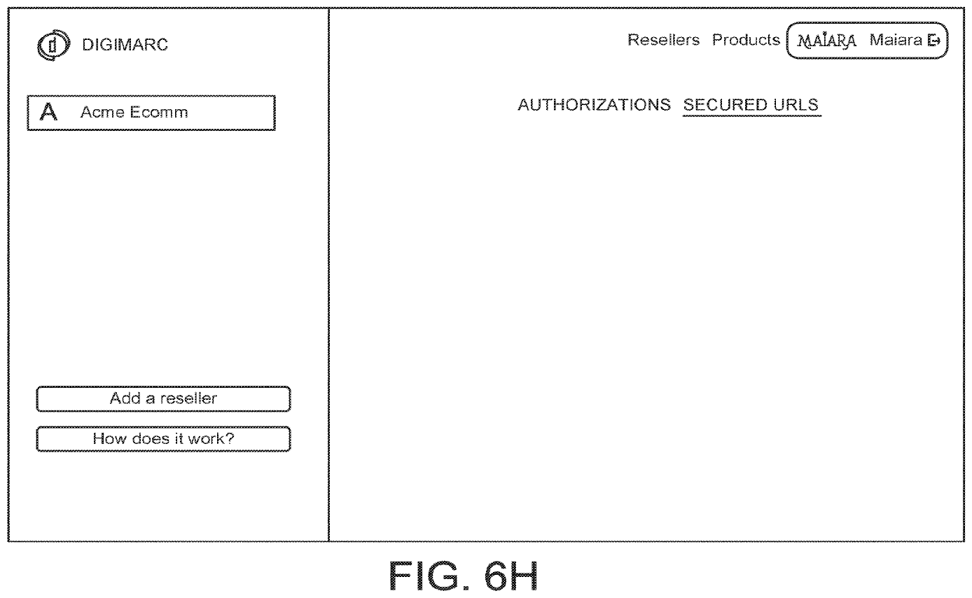

A system implementation of digital watermark based-counterfeit deterrence technology is discussed with reference to FIGS. 6A-9C.

FIG. 6A shows a brand login or sign-in to access an “online validation system” or interchangeable, a “digital watermark-based counterfeit deterrence system”. The online validation system includes, e.g., software instructions executing on one or more multi-core processors, e.g., two or more multi-core parallel processors, executing on cloud-based servers, or running on a Platform as a service (PaaS) or as Software as a Service (SaaS). The software instructions provide an online environment. The online environment includes a plurality of graphical user interfaces (GUIs) and/or Application Program Interfaces (“API”). The software instructions may also include, call and/or communicate with a variety of other modules, networks and systems, e.g., a digital watermarking embedder, digital watermark decoder, digital image repository, databases and/or data records, and account management modules. Returning to FIG. 6A, for example, brand “Maiara” logs into the online validation system with a username/password, and/or other authentication requirements such as two-factor (2FA), multi-factor authentication, private public key pairs or a blockchain wallet (e.g., via a Metamask extension). FIG. 6B shows an example GUI presented to the brand by the online validation system to allow the brand to add, delete and/or modify products authorized for resale. When adding a product, the brand can identify or add a product name, and upload, e.g., drag-and-drop or otherwise select, product digital imagery from a storage location. Alternatively, product digital imagery can be added by entering a URL or file storage location that hosts the imagery. In the FIG. 6B example, an image of a creamy lotiony product, Maiara “cream,” is shown. The online validation system provides additional GUIs accessible to the brand to monitor an authorized product and its associated analytics (FIG. 6C), counterfeit attempts (FIG. 6D) and authorized distribution points, e.g., URLs listing the product (FIG. 6E). These GUIs do not yet include information since the product was just added by the brand.

FIG. 6F shows another GUI provided by the online validate system to allow the brand to identify authorized resellers that can sell the brand's product(s). The resellers can be identified by name, account identifier, and/or URL(s). A dropdown list of previously entered retailers can be maintained to ease data entry. An online retailer, e.g., Acme Ecomm, is added as an authorized reseller. See FIG. 6G which shows that this retailer is authorized to resell the subject product, Maiara cream. An “Authorizations” tab can be accessed to view additional products that this reseller has been authorized to resell. Another tab, “Secured URLS” is empty in FIG. 6H since the reseller, Acme Ecomm, has not yet provided a Product URL (or series of Product URLs) that will be hosting the product, Maiara cream, for resell.

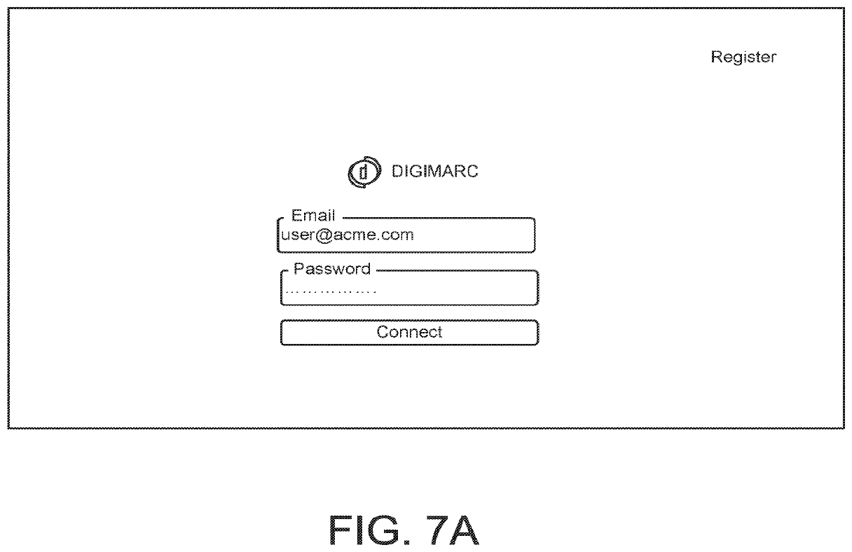

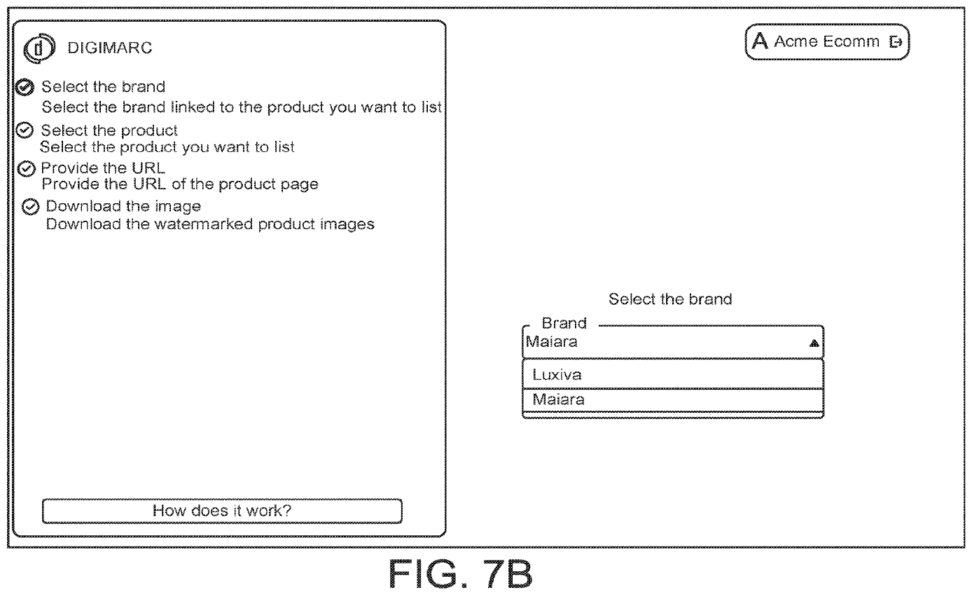

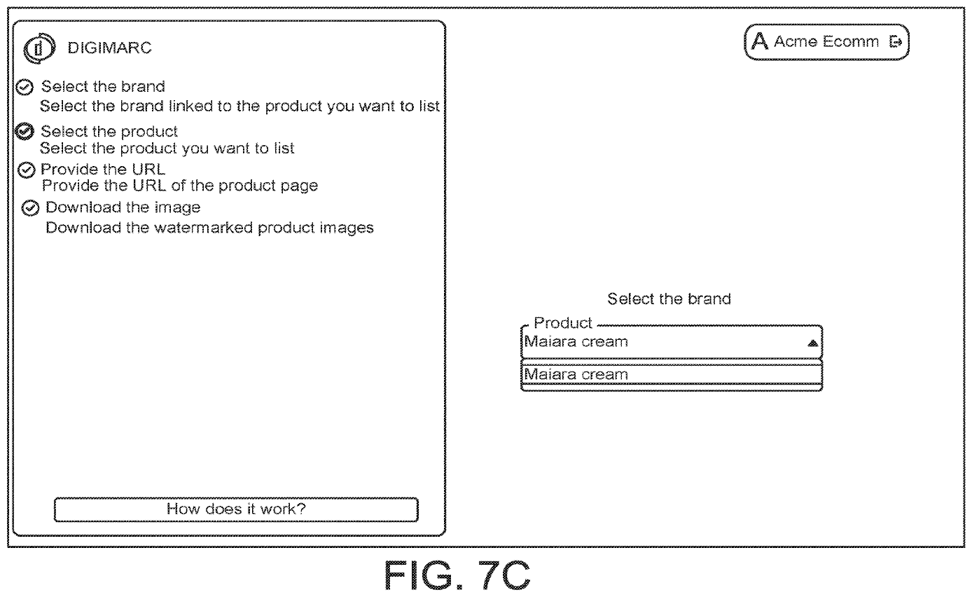

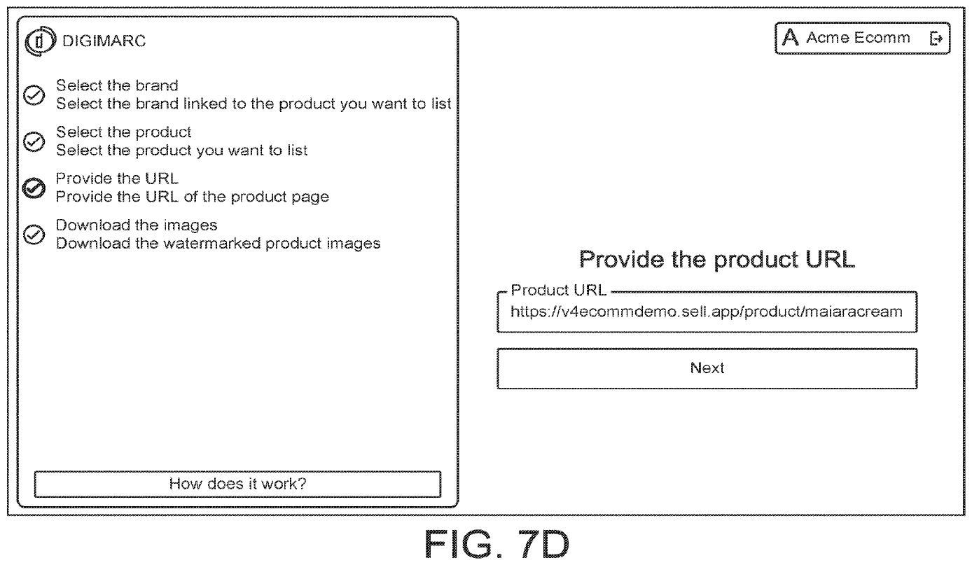

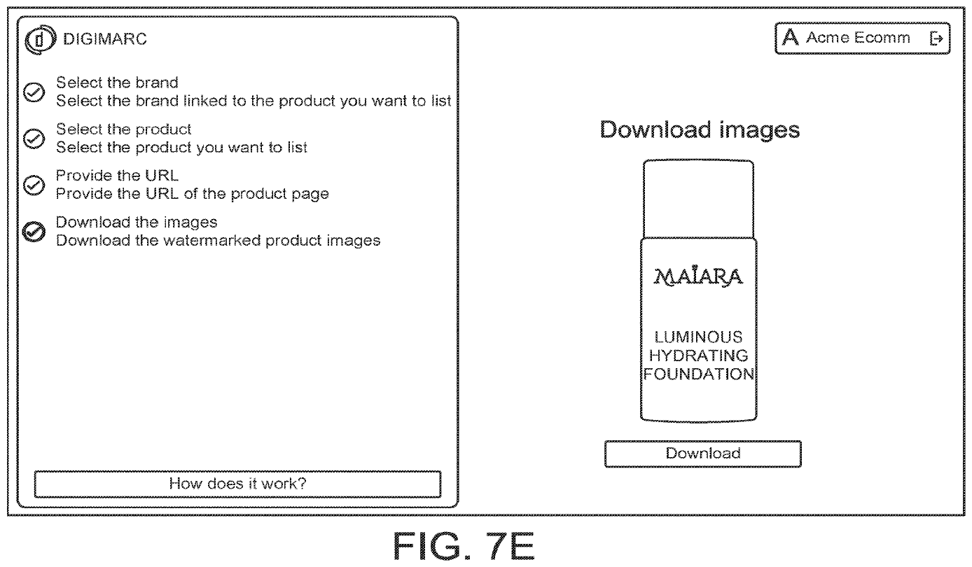

Reseller Acme Ecomm has an account with the online validation system and enters the system via a user login GUI as shown in FIG. 7A. 2FA, multi-factor authentication, private public key pairs or a blockchain wallet, can be used to further secure the account. Once signed into the validation system, as shown in FIG. 7B, the reseller is presented with a GUI to select a particular brand, here “Maiara”. Recall from above that the brand has already identified Acme Ecomm as an authorized reseller, so the online validation system associates the brand (e.g., via an account identifier) with the reseller account. The reseller can select pre-authorized brands from a dropdown menu, or enter the brand name. The brand has already pre-authorized a specific product for this reseller, here the Maiara cream. So, the cream is available to the reseller for selection via a menu or graphic (not shown in FIG. 7C). For example, the graphic may include a thumbnail version of the previously-upload product digital imagery. Once the pre-authorized product is selected, the reseller enters a Product URL that will host the product for sale. Here, the Product URL is: https://v4ecommdemo.sell.app/product/maiaracream as shown in FIG. 7D.

The online validation system includes or communicates with a digital watermark embedder to embed validation clues carried by digital watermarking within product digital imagery. The digital watermark embedder receives inputs to construct a plural-bit payload to embed within the product digital imagery associated with the product, here a digital image depicting the Maiara cream. In a first implementation, the plural-bit payload may include, e.g., a concatenated bit-string representing some or all of: i) a product identifier for the Maiara cream, and/or ii) the Product URL. In a second implementation, different digital watermark payload fields carry such information. In a third implementation, the payload carries an index or other identifier that is used to query into a database, table or other data repository. The database, table or other data repository hosts the product identifier information and the Product URL, indexed according to the embedded index or other identifier. In a fourth implementation, the plural-bit payload includes a hash or fingerprint representing the data of any of implementations one, two or three. The hash may include a reduced-bit representation of the data. In a fifth implementation, the plural-bit payload carries SSL certificate information corresponding to the Product URL and product identification information. In a sixth implementation, the plural-bit payload carries some or all of the Product URL. In a seventh implementation, the data of any of implementations one, two, three, four, five or six is signed with a key identifying the brand or the reseller (e.g., via Decentralized Identifiers-DIDs). Once constructed, the plural-bit payload is embedded into the product digital imagery using digital watermarking. This plural-bit payload carries validation clues to be used to validate authenticity of the product and/or reseller. The digital watermarking preferably alters perceptual elements (e.g., pixel values, color values, luminance or chrominance values) of the digital image to carry the plural-bit payload. In some implementations, the digital watermarking includes a synchronization component. The digital watermark embedder produces a digital watermarked product digital image. In FIG. 7E, the digital watermarked product digital image is available to the reseller to download (or URL copy) for use on the Product URL.

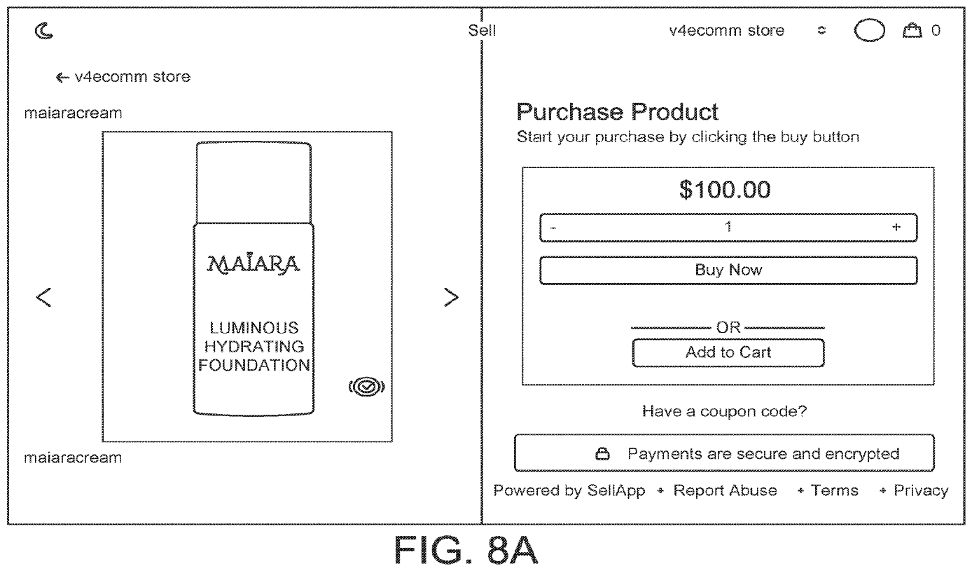

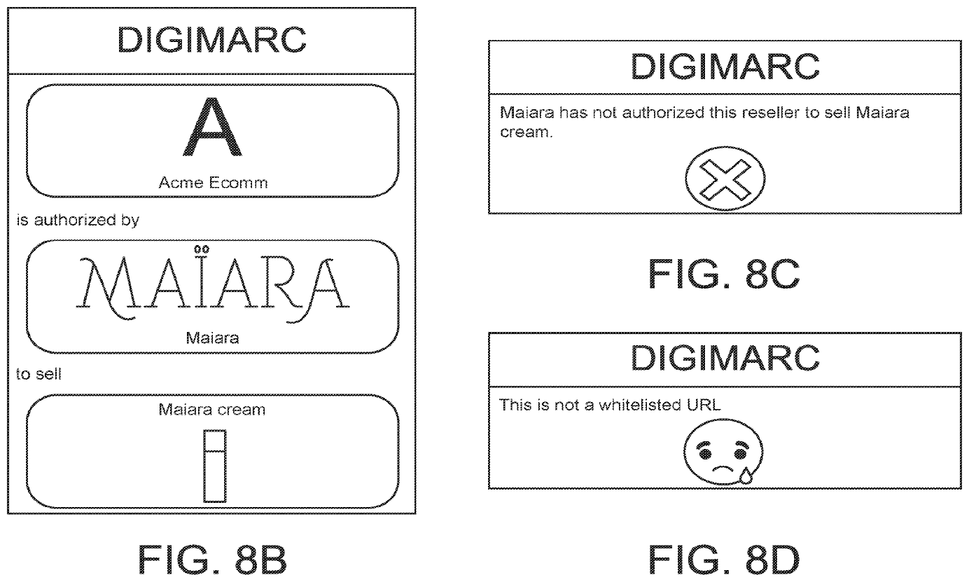

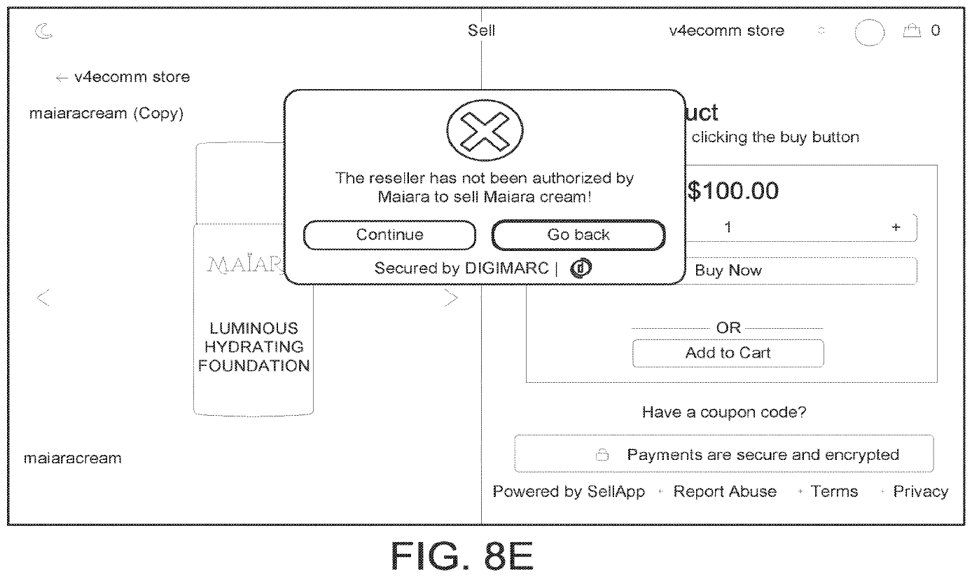

The Acme Ecomm reseller runs or uses an e-commerce store (“v4ecomm store”) and posts the digital watermarked product digital image on the Product URL, along with product and sales information. See FIG. 8A.

A consumer shopping on the online v4ecomm store, e.g., on a mobile device, tablet or desktop computer, is savvy, so she verifies authenticity of the listed product (Maiara cream) and corresponding reseller. She activates a validation module to test the authenticity of the product and reseller. The validation module includes or calls a digital watermark decoder. The digital watermark decoder analyzes the digital watermarked product digital image imagery displayed at the Product URL to decode the plural-bit payload carried by the embedded digital watermarking. Validation clue information is obtained from the plural-bit payload and is used to validate the product and authority of the reseller to sell the product. Validation includes comparing the decoded plural-bit payload information (e.g., decoded validation clues) with information associated with the Product URL (e.g., scraped validation clues). For example, the validation module comprises functionality, e.g., provided by software instructions, to scrape, collect or read the Product URL for information (e.g., collectively, “scraped validation clues”) to compare against the decoded digital watermark plural-bit payload. For example, such scraped validation clue information, including product identifier, Product URL information and/or SSL certificate information, is obtained from the Product URL (e.g., found in JavaScript, HTML and/or CSS; and for SSL information: found via execution of browser plugin code, cross-site JavaScript code, command-based tools such as Keytool, OpenSSL, Nmap, and web-based tools such as SurfaceBrowser SSL Analyzer or Qualys SSL Test or, in the case of a mobile application capturing imagery of a displayed website, via a camera and OCR). If the digital watermark plural-bit payload includes a hash of such information, the validation module can generate a hash of the scraped or collected information using the same algorithm (or key set) as was used to create the digital watermark payload. Alternatively, the validation module can call the online validation system for validation. In this alternative case, the validation module provides scrapped validation clue information to the online validation system and an address of the digital imagery. The validation module (or, in the alternative case, the online validation system) decodes the digital watermark plural-bit payload and performs a comparison with the scrapped information to determine if the product is authorized for resale by the reseller. If SSL certification information is used for validation comparison, different portions of the SSL certificate can be used for validation: e.g., a comparison of the hash of the certificate with the watermark carried hash, by a comparison of the issuer and serial number of the scraped info vs. watermark payload version, and/or by the fingerprint/subject key identifier (SKID) of the scraped info vs. watermark payload version. The digital watermark payload may include a flag bit(s) or payload field to identify which SSL certification information to use for validation. Validation results can be displayed to the user, and, preferably, also communicated to the online validation system. For example, a popup window, or other notification, generated by the validation module, can show a successful validation (checkmark graphic in FIG. 8A; and FIG. 8B), display a warning that the validation failed (FIGS. 8C and 8E), or that the digital image is not digital watermarked and/or that the Product URL has not gone through an authorization (FIG. 8D).

One implementation of the validation module is a dedicated web browser extension. Such extensions are typically software programs that can modify and enhance the functionality of a web browser. Extensions can be written using, e.g., HTML, CSS (“Cascading Style Sheets”), and/or JavaScript. The web browser extension can deploy a digital watermark decoder, e.g., via decoder code incorporated via software instructions within the web browser extension, or, alternatively, deployed by being called by the web browser extension. If the web browser extension calls a remotely located digital watermark decoder, the web browser extension can provide the digital imagery to the digital watermark decoder. In another implementation, the web browser extension provides a web address hosting the digital imagery to the digital watermark decoder, which accesses the digital content by visiting the web address. The web browser extension allows a consumer to verify the authenticity of the reseller to sell the product depicted in the digital imagery on the corresponding website. For example, the web browser extension, running in the background and/or once activated (e.g., clicking on an icon or displayed widget), deploys a digital watermark decoder to analyze the digital imagery. The digital watermark detector analyzes the digital image to locate and decode a plural-bit payload carried therein.

Instead of using a browser extension, the validation module, including the decoder and validation/comparison features discussed above, can be incorporated into a standalone application or into the e-commerce site itself. For example, a reseller could build the validation module into their online retail store, e.g., as a feature available to registered customers. In an alternative, a plug-in is used instead of a web browser extension. In still another alternative, the decoder and validation/comparison features are provided by a webpage or web service. In this case, a product can be verified by sending the web address (URL) of the product to the webpage or web service. This allows for instance verification in browsers that do not support extensions (e.g., some mobile browsers) and could use for example a bookmarklet-a bookmark stored in a web browser that contains JavaScript commands that add new features to the browser. Also, instead of using a web browser extension, a smartphone running a validation app could be used to search for digital watermarking included with displayed or encountered digital imagery. In another mobile application, a mobile device captures imagery of a display website (e.g., displayed on a computer monitor external related to the mobile device). The mobile device analyzes the captured imagery to find the digital watermark in an image and the website address via OCR.

Returning to the online validation system discussed with reference to FIGS. 6A-7E, the brand account pages can be populated with information to provide counterfeit surveillance and product distribution information. For example, FIG. 9A illustrates the previously empty “Secured URLS” tab as shown in FIG. 6E. This tab is updated in FIG. 9A to show the Product URL provided by the reseller and associated with a previously authorized product. Validation modules operating across many different online retail stores (and/or via a 3^{rd} party service) preferably communicate validation information (e.g., including product information and reseller information) back to the online validation system. This information provides powerful crowdsourced counterfeiting surveyance information to the brand. For example, in FIG. 9B under the “Analytics” tab, a number of successful and unauthorized validation attempts can be displayed. Under the “Guardian” tab in FIG. 9C, URL information associated with unauthorized product URLs can be displayed. (Data records, databases, tables, etc. can be used to store counterfeiting surveyance information. Such information can be accessed from the data records, databases and/or tables and displayed in graphical and/or text form via a GUI.)

The terms “retailer” and “reseller” should not be viewed as limiting. They simply mean a party that sells a product. These retailer and reseller terms is used broadly in this document to include parties such as product sellers, distributors, wholesalers, store owners, e-commerce site operators or retailer or sellers, and even brand owners themselves (e.g., when operating or selling an e-commerce site to sell a product).

### Concluding Remarks

The technology, modules, functionality, methods, processes, and systems described above may be implemented in hardware, software or a combination of hardware and software. For example, the validation module described above may be implemented as instructions stored in a memory and executed in one or more processors (including both software and firmware instructions), implemented as digital logic circuitry in a special purpose digital circuit, or combination of instructions executed in one or more multi-core processors, one or more parallel processors and/or one or more digital logic circuit modules. For example, the validation module described above may be implemented as instructions stored in a memory and executed in one or more multi-core processors (including both software and firmware instructions), implemented as digital logic circuitry in a special purpose digital circuit, or combination of instructions executed in one or more multi-core processors, one or more parallel processors and/or one or more digital logic circuit modules. The technology, modules, methods, services, functionality and processes described above may be implemented in software programs executed from a system's memory (a non-transitory computer readable medium such as an electronic, solid-state, optical and/or magnetic storage memory). When the software is executed, its software instructions cause one or more processors, one or more multi-core processors, one or more parallel processors to execute or carry out the various acts or functionality scripted therein. The methods, instructions and circuitry operate on electronic signals, or signals in other electromagnetic forms. These signals further represent physical signals like image signals captured in image sensors, audio captured in audio sensors, as well as other physical signal types captured in sensors for that type. These electromagnetic signal representations are transformed to different states as detailed above to detect signal attributes, perform pattern recognition and matching, determine relative attributes of Scans, etc.

Example hardware and communication flow between electronic devices, networks and third-party services (e.g., provided by cloud-based computers as cloud-based services) is further detailed in our PCT Application No. PCT/US22/50767, which is hereby incorporated here by reference including all drawings, particularly relative to FIGS. 14, 15 and 16 of that PCT application, and we expressly intend to use those described computing environments with the technology described in the present patent document as if reproduced word for word herein. For example, the digital watermark embedder and detector may be hosted on a cloud resource depicted in one or more those figures, and accessed via one or more APIs or graphical interfaces.

Having described and illustrated the principles of the technology with reference to specific implementations, it will be recognized that the technology can be implemented in many other, different, forms. To provide a comprehensive disclosure without unduly lengthening the specification, applicants incorporate by reference-in their entirety-the patents and patent applications referenced above, including all drawings, and any appendices.

The particular combinations of elements and features in the above-detailed embodiments are exemplary; the interchanging and substitution of these teachings with other teachings in this and the incorporated-by-reference patents/applications are also contemplated. Any headings used in this document are for the reader's convenience and are not intended to limit the disclosure. We expressly contemplate combining the subject matter under the various headings.

What is claimed is:

1. An image processing method comprising:
accessing digital imagery depicting a physical product from a hosting address, the digital imagery comprising digital watermarking embedded therein, the digital watermarking carrying a plural-bit payload comprising validation clues, the validation clues comprising hosting address information;
analyzing, using a digital watermark decoder, the digital imagery to decode the plural-bit payload, said analyzing yielding decoded validation clues comprising decoded hosting address information;
scraping validation clues from data associated with the hosting address, said scraping yielding scraped validation clues comprising scraped hosting address information;
generating a comparison based on the scraped validation clues and the decoded validation clues;
determining whether the physical product is authorized or genuine based on said comparison.

2. The image processing method of claim 1 in which the validation clues also comprise product identification information for the physical product depicted in the digital imagery, and in which the decoded validation clues also comprise decoded product identification information for the physical product depicted in the digital imagery, and in which the scraped validation clues also comprise scraped product identification information.

3. The image processing method of claim 1 in which said generating the comparison comprises generating a hash of the scraped validation clues to yield a generated hash, in which the decoded validation clues comprise a decoded hash, and in which the comparison represents a comparison of the generated hash and the decoded hash.

4. The image processing method of claim 2 in which the scraped validation clues each comprises clear text representing the scraped product identification information and scraped hosting address information, and in which the decoded product identification information for the physical product depicted in the digital imagery and decoded hosting address information each comprises clear text.

5. The image processing method of claim 2, in which the scraped product identification information and the decoded product identification information each comprise at least one of a Stock Keeping Unit (SKU), a Manufacturer Part Number (MPN), a Global Trading Item Number (GTIN), an Amazon Standard Identification Number (ASIN), a Universal Product Code (UPC), an International Standard Book Number (ISBN), a European Article Number (EAN), or a GS1 Digital Link.

6. The image processing method of claim 1 in which the scraped hosting address information and the decoded hosting address information each comprise a plain text address, or a Uniform Resource Identifier (URI), or a reduced-bit version of either.

7. The image processing method of claim 1 in which the scraped hosting address information and the decoded hosting address information each comprise at least Secure Sockets Layer (SSL) certificate information.

8. The image processing method of claim 7 in which the SSL certificate information comprises at least one item from a group of items comprising: domain name, website address, organizational name certificate issued to, issuing authority, issuing authority's digital signature, certificate issue date, certificate expiry date, authority key identifier (AKID), and subject key identifier (SKID).

9. The image processing method of claim 1 in which said analyzing calls a remotely located digital watermark decoder.

10. The image processing method of claim 1 in which said acts are carried out within a web browser extension, plug-in or cloud-based service.

11. A non-transitory computer readable medium comprising software instructions stored thereon that, when executed by one or more multi-core processors, cause said one or more multi-core processors to perform the following acts:
accessing digital imagery depicting a physical product from a hosting address, the digital imagery comprising digital watermarking embedded therein, the digital watermarking carrying a plural-bit payload comprising validation clues, the validation clues comprising hosting address information;
analyzing the accessed digital imagery to decode the plural-bit payload, said analyzing yielding decoded validation clues comprising decoded hosting address information;
scraping validation clues from data associated with the hosting address, said scraping yielding scraped validation clues comprising scraped hosting address information;
generating a comparison based on the scraped validation clues and the decoded validation clues;
determining whether the physical product is authorized or genuine based on said comparison.

12. The non-transitory computer readable medium of claim 11, in which the validation clues also comprise product identification information for the physical product depicted in the digital imagery, and in which the decoded validation clues also comprise decoded product identification information for the physical product depicted in the digital imagery, and in which the scraped validation clues also comprise scraped product identification information.

13. The non-transitory computer readable medium of claim 11 in which said generating the comparison comprises generating a hash of the scraped validation clues to yield a generated hash, in which said decoded validation clues comprises a decoded hash, and in which said comparison represents a comparison of the generated hash and the decoded hash.

14. The non-transitory computer readable medium of claim 12 in which the scraped validation clues each comprises clear text representing the scraped product identification information and scraped hosting address information, and in which the decoded product identification information for the physical product depicted in the digital imagery and decoded hosting address information each comprises clear text.

15. The non-transitory computer readable medium of claim 12, in which the scraped product identification information and the decoded product identification information each comprises at least one of a Stock Keeping Unit (SKU), a Manufacturer Part Number (MPN), a Global Trading Item Number (GTIN), an Amazon Standard Identification Number (ASIN), a Universal Product Code (UPC), an International Standard Book Number (ISBN), a European Article Number (EAN) or a GS1 Digital Link.

16. The non-transitory computer readable medium of claim 11 in which the scraped hosting address information and the decoded hosting address information each comprises at least one of a plain text address, or a Uniform Resource Identifier (URI), or a reduced-bit version of either.

17. The non-transitory computer readable medium of claim 11 in which the scraped hosting address information and the decoded hosting address information each comprises at least Secure Sockets Layer (SSL) certificate information.

18. The non-transitory computer readable medium of claim 17 in which the SSL certificate information comprises at least one item from a group of items comprising:
domain name, website address, organizational name certificate issued to, issuing authority, issuing authority's digital signature, certificate issue date, certificate expiry date, authority key identifier (AKID), and subject key identifier (SKID).

19. The non-transitory computer readable medium of claim 11 in which said analyzing calls a remotely located digital watermark decoder to carry out said act of analyzing.

20. The non-transitory computer readable medium of claim 11 in which said software instructions are incorporated within a web browser extension, plug-in or cloud-based service.
